(19) United States
(12) Patent Application Publication
(10) Pub. No.: US 2024/0302759 A1
(43) Pub. Date: Sep. 12, 2024

(54) PROCESS CARTRIDGE AND IMAGE FORMING APPARATUS

(71) Applicant: FUJIFILM Business Innovation Corp., Tokyo (JP)

(72) Inventors: Yukimi KAWABATA, Kanagawa (JP); Kenta YAMAKOSHI, Kanagawa (JP); Takuya YAMAMOTO, Kanagawa (JP)

(73) Assignee: FUJIFILM Business Innovation Corp., Tokyo (JP)

(21) Appl. No.: 18/432,038

(22) Filed: Feb. 4, 2024

(30) Foreign Application Priority Data
Mar. 3, 2023 (JP) 2023-033061
Sep. 21, 2023 (JP) 2023-156331

(51) Int. Cl. G03G 5/14

(52) U.S. Cl. CPC G03G 5/142; G03G 2215/00957; G03G 2215/00962; G03G 2221/183

(57) ABSTRACT

A process cartridge includes an electrophotographic photoreceptor that includes a photosensitive layer and a protective layer on a conductive substrate in this order, and a charging member that includes an elastic layer and a surface layer on a conductive base material in this order and comes into contact with the electrophotographic photoreceptor to charge a surface of the electrophotographic photoreceptor, in which the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and a water contact angle θ2 of a surface of the charging member satisfies a relationship of θ1<θ2.

### CROSS-REFERENCE TO RELATED APPLICATIONS

This application is based on and claims priority under 35 USC 119 from Japanese Patent Application No. 2023-156331 filed Sep. 21, 2023 and Japanese Patent Application No. 2023-033061 filed Mar. 3, 2023.

### BACKGROUND

### (i) Technical Field

The present disclosure relates to a process cartridge and an image forming apparatus.

### (ii) Related Art

For example, JP1994-175466A discloses a contact charging device that charges a photoreceptor by applying a voltage to a conductive roll coming into contact with a surface of the photoreceptor, in which the conductive roll covers a conductive layer on a lower layer side so that the conductive roll comes into contact with the surface of the photoreceptor and includes a surface layer having a contact angle greater than the contact angle of the surface of the photoreceptor, and an image forming apparatus including the contact charging device.

Further, JP3747633B discloses an electrophotographic apparatus including an electrophotographic photoreceptor and a contact type charging member provided at a position in contact with the photoreceptor, in which the contact type charging member forms a contact surface with the electrophotographic photoreceptor using a hydrophobic elastic member, a pure water contact angle of the surface is set to 105 degrees or greater, a pure water contact angle of the surface of the electrophotographic photoreceptor is set to 95 degrees or higher, and a pure water contact angle Ro of the surface of the electrophotographic photoreceptor and a pure water contact angle Rc of the surface of the contact type charging member satisfy Expression: 0 degrees≤|Ro-Rc|≤5 degrees.

Further, JP2595635B discloses an electrophotographic photoreceptor in which a charge transport layer consisting of an organic substance and a charge generation layer consisting of an organic substance are laminated on a conductive substrate, the charge generation layer is covered with a surface protective layer consisting of a mixture of a urethane resin and tetraethyl silicate, and the pure water contact angle measured in air on the surface of the surface protective layer is in a range of 70 degrees to 75 degrees.

### SUMMARY

Aspects of non-limiting embodiments of the present disclosure relate to a process cartridge in which a protective layer in an electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH and which is capable of suppressing streak-like image density unevenness as compared with a case where a water contact angle θ1 of the surface is less than 65° or 80° or greater or a case where a water contact angle θ2 of the surface of the charging member satisfies a relationship of θ1≥θ2.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

The following means are provided in order to achieve the above-described object.

According to an aspect of the present disclosure, there is provided a process cartridge including: an electrophotographic photoreceptor that includes a photosensitive layer and a protective layer on a conductive substrate in this order; and a charging member that includes an elastic layer and a surface layer on a conductive base material in this order and comes into contact with the electrophotographic photoreceptor to charge a surface of the electrophotographic photoreceptor, in which the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and a water contact angle θ2 of a surface of the charging member satisfies a relationship of θ1<θ2.

### BRIEF DESCRIPTION OF THE DRAWINGS

Exemplary embodiment(s) of the present invention will be described in detail based on the following figures, wherein:

FIG. 1 is a schematic partial cross-sectional view showing an example of a layer configuration of an electrophotographic photoreceptor according to the present exemplary embodiment;

FIG. 2 is a schematic perspective view showing an example of a configuration of a charging member according to the present exemplary embodiment;

FIG. 3 is a schematic configuration view showing an example of an image forming apparatus according to the present exemplary embodiment; and

FIG. 4 is a schematic configuration view showing another example of the image forming apparatus according to the present exemplary embodiment.

### DETAILED DESCRIPTION

Hereinafter, an exemplary embodiment which is an example of the present invention will be described in detail with reference to the accompanying drawings. The following descriptions and examples merely illustrate the exemplary embodiments, and do not limit the scope of the exemplary embodiments.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to the accompanying drawings, the configuration of the exemplary embodiment is not limited to the configuration shown in the drawings. In addition, the sizes of members in each drawing are conceptual and the relative relation in the sizes between the members is not limited thereto. Further, members having common functions and actions are denoted by the same reference numerals in all the drawings, and overlapping descriptions will not be repeated.

In the present disclosure, each component may contain a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

### Process Cartridge

A process cartridge according to the present exemplary embodiment is a process cartridge including: an electrophotographic photoreceptor that includes a photosensitive layer and a protective layer on a conductive substrate in this order, and a charging member that includes an elastic layer and a surface layer on a conductive base material in this order and comes into contact with the electrophotographic photoreceptor to charge a surface of the electrophotographic photoreceptor, in which the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface is 65° or greater and less than 80°, and a water contact angle θ2 of the surface of the charging member satisfies a relationship of θ1<θ2.

Hereinafter, “electrophotographic photoreceptor” will also be simply referred to as “photoreceptor”, and “charging member that comes into contact with the electrophotographic photoreceptor to charge the surface of the electrophotographic photoreceptor” will also be referred to as “contact type charging member”.

For example, as described in JP3747633B, an image forming apparatus that prevents a toner from remaining on the surface and maintains stabilized charging characteristics without adhesion of dirt even in a case of long-term use by increasing the water contact angle of the surface of the photoreceptor and the water contact angle of the surface of the contact type charging member and hydrophobizing each surface thereof is known.

However, even in such an image forming apparatus, “slip-through” in which the toner slips between a surface of the photoreceptor and an edge of a cleaning blade that cleans the surface of the photoreceptor occurs depending on the use environment (for example, a high-temperature and high-humidity environment or a low-temperature and low-humidity environment), and thus the surface of the photoreceptor and the surface of the contact type charging member are contaminated in some cases. In a case where the surface of the photoreceptor and the surface of the contact type charging member are contaminated, streak-like image density unevenness occurs in an output image in a state where streaks extend in a circumferential direction of the photoreceptor.

The photoreceptor of the process cartridge according to the present exemplary embodiment includes a protective layer that is a cured film formed to contain a crosslinked material of a composition containing the compound X and the charge transport material Y. Such a photoreceptor including a protective layer tends to have high durability against discharge stress and mechanical abrasion applied to the photoreceptor in an electrophotographic process. In addition, it is assumed that in a case where the water contact angle θ1 of the surface of the photoreceptor is set to 65° or greater and less than 80°, the slip-through amount of the toner can be reduced due to the relationship with the edge of the cleaning blade. In this manner, since the absolute amount of the toner remaining on the surface of the photoreceptor is reduced, the use environment (for example, a high-temperature and high-humidity environment or a low-temperature and low-humidity environment) is difficult to influence, and the contamination of not only the surface of the photoreceptor but also the surface of the charging member can be suppressed.

In general, since the relationship of “water contact angle≈adhesive force of toner” tends to be satisfied, the water contact angle of the surface of the charging member is greater than the water contact angle of the surface of the photoreceptor (that is, the relationship of θ1<θ2 is satisfied) so that the toner (including an external additive for liberating from the toner) is unlikely to travel to the surface of the charging member from the surface of the photoreceptor, and thus the contamination of the surface of the charging member is further suppressed. As a result, it is assumed that the streak-like image density unevenness can be suppressed.

As described above, the process cartridge according to the present exemplary embodiment can suppress streak-like image density unevenness.

### Aspects

In the present exemplary embodiment, the difference [θ2−θ1] between the water contact angle θ2 and the water contact angle θ1 is, for example, preferably 1° or greater and more preferably 3° or greater.

Further, the upper limit of the difference [θ2−θ1] may be, for example, 250 and is preferably 10° from the viewpoint of suppressing streak-like image defects.

That is, the difference [θ2−θ1] is, for example, preferably 10 or greater and 100 or less and more preferably 3° or greater and 100 or less.

Further, the water contact angle θ1 is 650 or greater and less than 800 and, for example, preferably 650 or greater and 750 or less from the viewpoint of an environmental difference between the slip-through amount and the abrasion amount depending on the curing degree of the cured film.

Here, the water contact angle is measured as follows.

Adhesive materials and the like on both the surface of the photoreceptor and the surface of the charging member are wiped with ethanol and wiped with a dry cloth.

Thereafter, the water contact angle of the surface of the photoreceptor as an object to be measured or the surface of the charging member is measured using a contact angle meter CA-X (trade name; manufactured by Kyowa Interface Science Co., Ltd.). Specifically, 3 μl of pure water is added dropwise to the surface of the object to be measured in an environment of a temperature of 25° C. and a relative humidity of 50%, and the droplet 20 seconds after the addition is imaged with an optical microscope. Then, the water contact angle is obtained from the obtained captured image. 9 sites on the surface of the photoreceptor, that is, sites spaced by 50 mm from the upper end, central sites, and sites spaced by 50 mm from the lower end of the protective layer are respectively measured three times. Further, 9 sites on the surface of the charging member, that is, sites spaced by 30 mm from end portions and central sites of the surface layer are respectively measured three times. In both cases, the arithmetic average values of the measured values are acquired and defined as the water contact angle θ1 and the water contact angle θ2.

### Electrophotographic Photoreceptor

First, the electrophotographic photoreceptor in the process cartridge according to the present exemplary embodiment will be described.

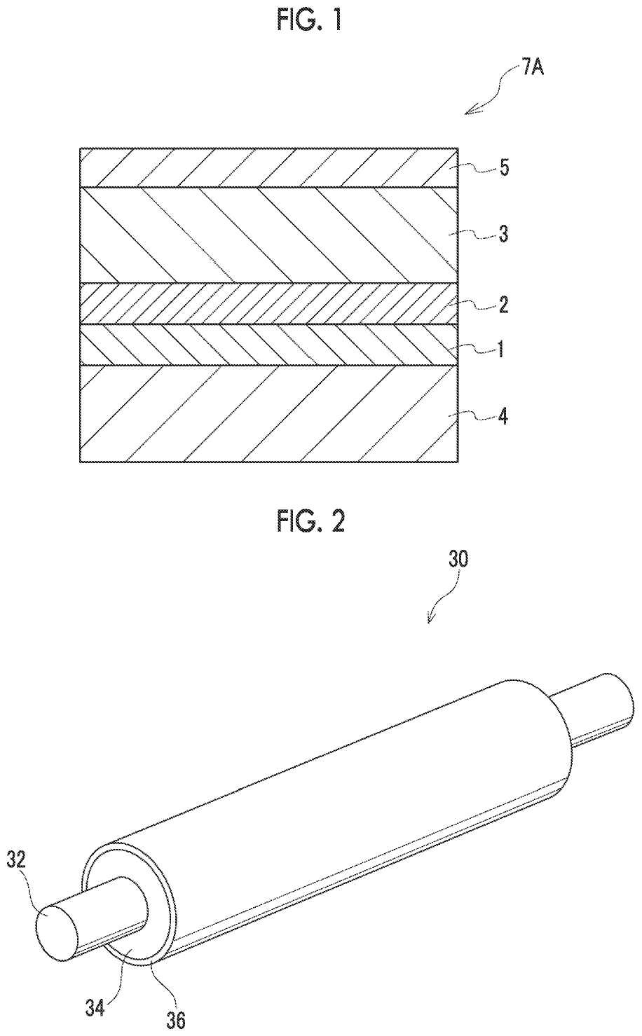

First, the layer configuration of the electrophotographic photoreceptor will be described with reference to the accompanying drawings. Here, FIG. 1 is a schematic cross-sectional view showing an example of the electrophotographic photoreceptor.

An electrophotographic photoreceptor 7A shown in FIG. 1 is a so-called function separation type photoreceptor (or lamination type photoreceptor) and has a structure in which an undercoat layer 1 is provided on a conductive substrate 4, and a charge generation layer 2, a charge transport layer 3, and a protective layer 5 are formed on the undercoat layer 1 in this order. In the electrophotographic photoreceptor 7A, the photosensitive layer is formed of the charge generation layer 2 and the charge transport layer 3.

The electrophotographic photoreceptor is not limited to the layer configuration shown in FIG. 1 and, for example, the undercoat layer 1 may be eliminated or an interlayer may be provided between the undercoat layer 1 and the photosensitive layer. Further, as shown in FIG. 1, the photosensitive layer of the electrophotographic photoreceptor is not limited to the lamination type of the charge generation layer 2 and the charge transport layer 3, and the photosensitive layer may be a single layer type photosensitive layer containing the charge generation material and the charge transport material in an identical layer.

In both configurations, the protective layer is a layer forming the surface of the electrophotographic photoreceptor, and in the present exemplary embodiment, the water contact angle θ1 of the surface of the protective layer, that is, the surface of the electrophotographic photoreceptor is set to 650 or greater and less than 80°.

Hereinafter, each layer of the electrophotographic photoreceptor according to the present exemplary embodiment will be described in detail. Further, the reference numerals will not be provided.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. Further, in a case where incoherent light is used as a light source, roughening of the surface to prevent interference fringes is not particularly necessary, and roughening of the surface to prevent interference fringes is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the micropores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 10² Ωcm or greater and 10¹¹ Ωcm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, the undercoat layer may contain an electron-accepting compound (acceptor compound) together with the inorganic particles, for example, from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

Further, the electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for an undercoat layer in which the above-described components are added to a solvent is formed, and the coating film is dried and, as necessary, heated.

Examples of the solvent for preparing the coating solution for an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for an undercoat layer include known methods such as a roll mill, a ball mill, a vibration ball mill, an attritor, a sand mill, a colloid mill, and a paint shaker.

Examples of the method of coating the conductive substrate with the coating solution for an undercoat layer include typical coating methods such as a blade coating method, a wire bar coating method, a spray coating method, a dip coating method, a bead coating method, an air knife coating method, and a curtain coating method.

The film thickness of the undercoat layer is set to be, for example, preferably in a range of 15 μm or greater and more preferably in a range of 20 μm or greater and 50 μm or less.

### Interlayer

Although not shown in the figures, an interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The film thickness of the interlayer is set to be, for example, preferably in a range of 0.1 μm or greater and 3 μm or less. Further, the interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine; chlorogallium phthalocyanine; dichloro-tin phthalocyanine; and titanyl phthalocyanine are more preferable.

On the other hand, for example, a fused ring aromatic pigment such as dibromoanthanthrone; a thioindigo-based pigmen, t a porphyrazine compound; zinc oxide; trigonal selenium; or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the electric field intensity in the photosensitive layer is increased, and a decrease in charge due to injection of a charge from the conductive substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer.

Further, the n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 10¹³ Ωcm or greater. These binder resins may be used alone or in the form of a mixture of two or more kinds thereof.

Further, the blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for a charge generation layer in which the above-described components are added to a solvent is formed, and the coating film is dried and, as necessary, heated. Further, the charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a micro-flow path in a high-pressure state.

During the dispersion, it is effective to set the average particle diameter of the charge generation material in the coating solution for a charge generation layer to 0.5 μm or less, for example, preferably 0.3 μm or less, and more preferably 0.15 μm or less.

Examples of the method of coating the undercoat layer (or the interlayer) with the coating solution for a charge generation layer include typical methods such as a blade coating method, a wire bar coating method, a spray coating method, a dip coating method, a bead coating method, an air knife coating method, and a curtain coating method.

The film thickness of the charge generation layer is set to be, for example, in a range of preferably 0.1 μm or greater and 5.0 μm or less and more preferably in a range of 0.2 μm or greater and 2.0 μm or less.

### Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

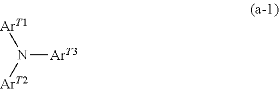

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

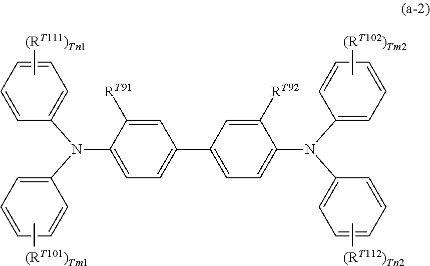

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. Further, the polymer charge transport material may be used alone or in combination of binder resins.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins are used alone or in combination of two or more kinds thereof.

Further, the blending ratio between the charge transport material and the binder resin is, for example, preferably in a range of 10:1 to 1:5 in terms of the mass ratio.

The charge transport layer may also contain other known additives.

The formation of the charge transport layer is not particularly limited, and a known forming method is used. For example, a coating film of a coating solution for a charge transport layer in which the above-described components are added to a solvent is formed, and the coating film is dried and, as necessary, heated.

Examples of the solvent for preparing the coating solution for a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for a charge transport layer include typical coating methods such as a blade coating method, a wire bar coating method, a spray coating method, a dip coating method, a bead coating method, an air knife coating method, and a curtain coating method.

The film thickness of the charge transport layer is set to be, for example, preferably in a range of 5 μm or greater and 50 μm or less and more preferably in a range of 10 μm or greater and 30 μm or less.

### Protective Layer

The protective layer is a cured film formed to contain a crosslinked material of a composition containing at least one compound X selected from the group consisting of a compound having a guanamine structure (hereinafter, also referred to as a guanamine compound) and a compound having a melamine structure (hereinafter, also referred to as a melamine compound) and a charge transport material Y containing at least one group selected from the group consisting of —OH, —OCH₃, —NH₂, —SH, and —COOH.

Further, the water contact angle θ1 of the surface of the surface layer, that is, the surface of the electrophotographic photoreceptor is 65° or greater and less than 80°.

Examples of a means of adjusting the water contact angle θ1 to be in the above-described range include adjustment of the kinds and the contents of each of the compound X and the charge transport material Y and adjustment of drying conditions.

### Compound X

### Guanamine Compound

First, the guanamine compound will be described.

The guanamine compound is a compound having a guanamine skeleton (structure), and examples thereof include acetoguanamine, benzoguanamine, formoguanamine, steroguanamine, spiroguanamine, and cyclohexylguanamine.

It is particularly preferable that the guanamine compound is, for example, at least one of a compound represented by General Formula (A) or a multimer thereof. Here, the multimer is an oligomer in which a compound represented by General Formula (A) is polymerized as a structural unit, and the polymerization degree thereof is, for example, 2 or greater and 200 or less (for example, preferably 2 or greater and 100 or less). Further, the compound represented by General Formula (A) may be used alone or in combination of two or more kinds thereof. In particular, in a case where two or more kinds of the compounds represented by General Formula (A) are mixed and used or the compound is used as a multimer (oligomer) having the compound as a structural unit, the solubility in a solvent is improved.

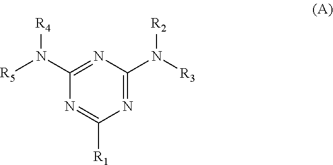

In General Formula (A), R₁ represents a linear or branched alkyl group having 1 or more and 10 or less carbon atoms, a substituted or unsubstituted phenyl group having 6 or more and 10 or less carbon atoms, or a substituted or unsubstituted alicyclic hydrocarbon group having 4 or more and 10 or less carbon atoms. R₂ to R₅ each independently represent a hydrogen atom, —CH₂—OH, or —CH₂—O—R₆. R₆ represents a hydrogen atom or a linear or branched alkyl group having 1 or more and 10 or less carbon atoms.

In General Formula (A), the alkyl group represented by R₁ has 1 or more and 10 or less carbon atoms, for example, preferably 1 or more and 8 or less carbon atoms, and more preferably 1 or more and 5 or less carbon atoms. Further, the alkyl group may be linear or branched.

In General Formula (A), the phenyl group represented by R₁ has 6 or more and 10 or less carbon atoms and, for example, more preferably 6 or more and 8 or less carbon atoms. Examples of the substituent substituted with the phenyl group include a methyl group, an ethyl group, and a propyl group.

In General Formula (A), the alicyclic hydrocarbon group represented by R₁ has 4 or more and 10 or less carbon atoms and, for example, more preferably 5 or more and 8 or less carbon atoms. Examples of the substituent substituted with the alicyclic hydrocarbon group include a methyl group, an ethyl group, and a propyl group.

In “—CH₂—O—R₆” represented by R₂ to R₅ in General Formula (A), the alkyl group represented by R₆ has 1 or more and 10 or less carbon atoms, for example, preferably 1 or more and 8 or less carbon atoms, and more preferably 1 or more and 6 or less carbon atoms. Further, the alkyl group may be linear or branched. Preferred examples thereof include a methyl group, an ethyl group, and a butyl group.

It is particularly preferable that the compound represented by General Formula (A) is, for example, a compound in which R₁ represents a substituted or unsubstituted phenyl group having 6 or more and 10 or less carbon atoms and R₂ to R₅ each independently represent-CH₂—O—R₆. Further, it is preferable that R₆ represents, for example, a group selected from a methyl group or an n-butyl group.

The compound represented by General Formula (A) is synthesized, for example, by a known method using guanamine and formaldehyde (for example, The fourth series of Experimental Chemistry, Vol. 28, p. 430).

Hereinafter, specific examples of the compound represented by General Formula (A) will be described, but are not limited thereto. Further, the following specific examples are monomers, but multimers (oligomers) having these monomers as structural units may be used.

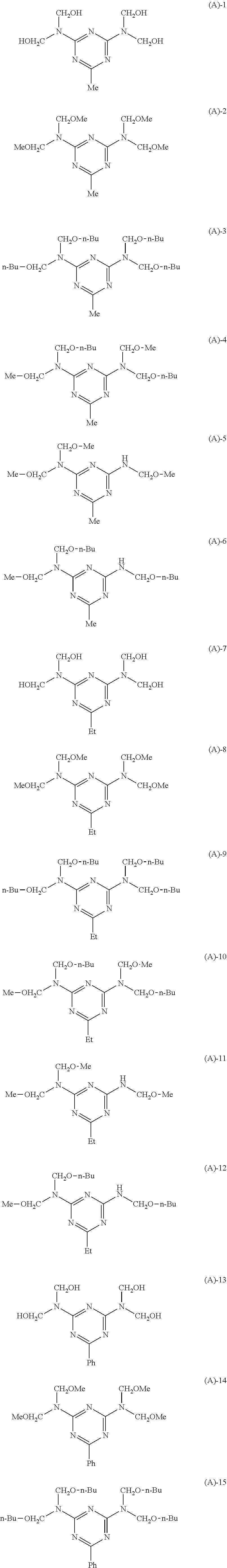

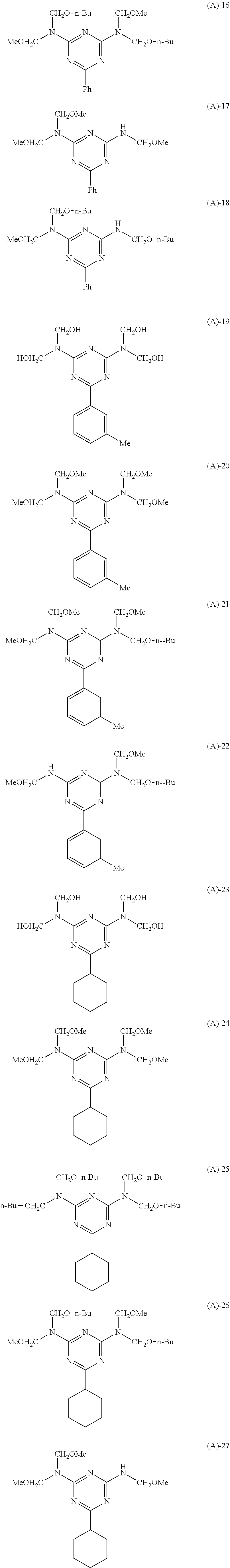

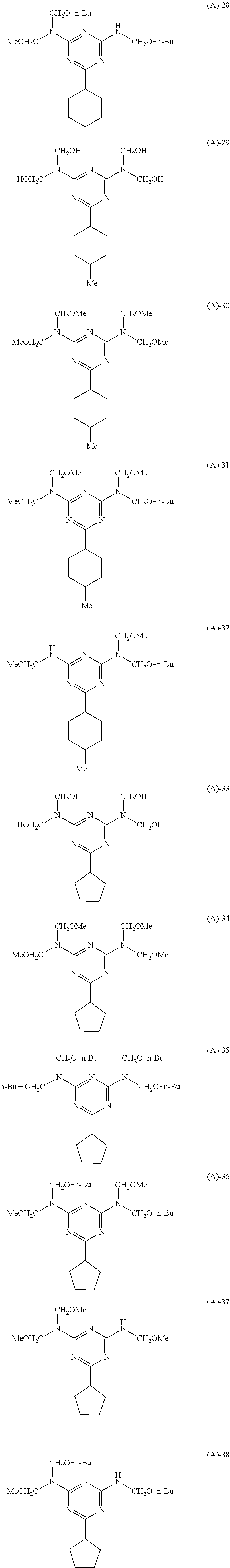

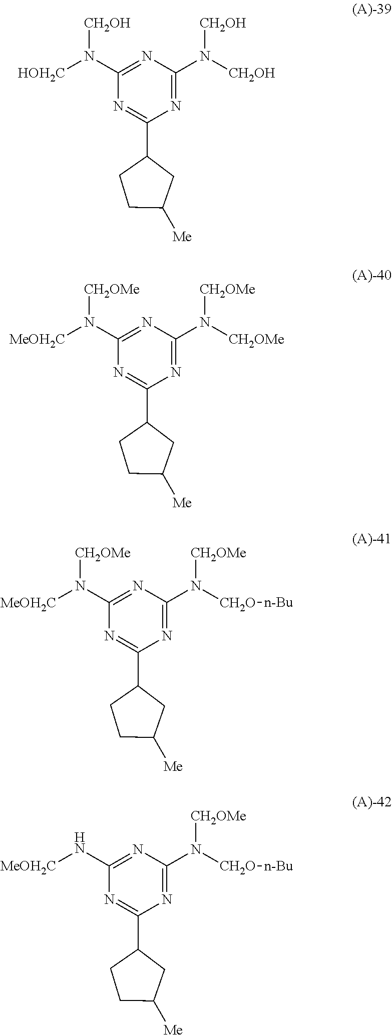

Examples of a commercially available product of the compound represented by General Formula (A) include SUPER BECKAMINE® L-148-55, SUPER BECKAMINE® 13-535, and SUPER BECKAMINE® L-145-60, and SUPER BECKAMINE® TD-126 (manufactured by DIC Corporation), and NIKALAC BL-60 and NIKALAC BX-4000 (manufactured by Nippon Carbide Industries Co., Inc.).

Further, the compound (including a multimer) represented by General Formula (A) may be dissolved in an appropriate solvent such as toluene, xylene, or ethyl acetate and washed with distilled water, ion exchange water, or the like, or treated with an ion exchange resin to be removed in order to eliminate the influence of a residual catalyst after synthesis or purchase of a commercially available product.

### Melamine Compound

Next, the melamine compound will be described.

It is preferable that the melamine compound is, for example, a compound having a melamine skeleton (structure) and is particularly at least one of a compound represented by General Formula (B) or a multimer thereof. Here, the multimer is an oligomer in which a compound represented by General Formula (B) is polymerized as a structural unit similar to General Formula (A), and the polymerization degree thereof is, for example, 2 or greater and 200 or less (for example, preferably 2 or greater and 100 or less). Further, the compound represented by General Formula (B) or the multimer thereof may be used alone or in combination of two or more kinds thereof. Further, the compound represented by General Formula (B) or the multimer thereof may be used in combination with the compound represented by General Formula (A) or the multimer thereof. In particular, in a case where two or more kinds of the compounds represented by General Formula (B) are mixed and used or the compound is used as a multimer (oligomer) having the compound as a structural unit, the solubility in a solvent is improved.

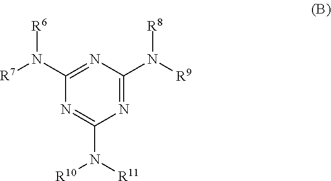

In General Formula (B), R⁶ to R¹¹ each independently represent a hydrogen atom, —CH₂—OH or —CH₂—O—R¹², and R¹² represents an alkyl group having 1 or more and 5 or less carbon atoms. The alkyl group may be branched, and specific examples thereof include a methyl group, an ethyl group, and a butyl group.

The compound represented by General Formula (B) is synthesized by a known method using, for example, melamine and formaldehyde (for example, synthesized in the same manner as the melamine resin in The fourth series of Experimental Chemistry, Vol. 28, p. 430).

Hereinafter, specific examples of the compound represented by General Formula (B) will be described, but are not limited thereto. Further, the following specific examples are monomers, but multimers (oligomers) having these monomers as structural units may be used.

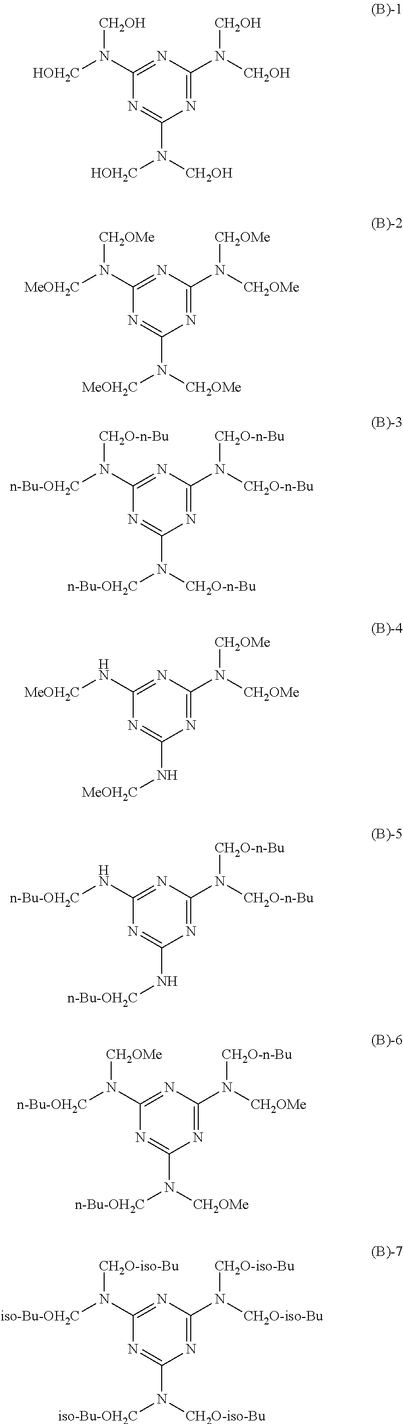

Examples of a commercially available product of the compound represented by General Formula (B) include SUPER MELAMI No. 90 (manufactured by NOF Corporation), SUPER BECKAMINE® TD-139-60 (manufactured by DIC Corporation), U-VAN 2020 (manufactured by Mitsui Chemicals, Inc.), SUMITEX RESIN M-3 (manufactured by Sumitomo Chemical Industry Co., Ltd.), and NIKALAC MW-30 (manufactured by Nippon Carbide Industries Co., Inc.).

Further, the compound (including a multimer) represented by General Formula (B) may be dissolved in an appropriate solvent such as toluene, xylene, or ethyl acetate and washed with distilled water, ion exchange water, or the like, or treated with an ion exchange resin for removal in order to eliminate the influence of a residual catalyst after synthesis or purchase of a commercially available product.

### Charge Transport Material Y

Next, the charge transport material Y will be described.

The charge transport material Y is a compound having at least one substituent (hereinafter, also referred to as a reactive substituent) selected from —OH, —OCH₃, —NH₂, —SH, and —COOH and having charge transport properties. In particular, examples of the charge transport material Y include materials having at least two (or three) substituents selected from —OH, —OCH₃, —NH₂, —SH, and —COOH. As described above, in a case where the number of reactive functional groups in the charge transport material Y is increased, the crosslinking density is increased, a crosslinked material with higher strength can be obtained, and thus surface abrasion of the electrophotographic photoreceptor is suppressed.

It is preferable that the charge transport material Y is, for example, a compound represented by General Formula (I).

F—((—R¹—X)ₙ₁R²—Y)ₙ₂ (I)

In General Formula (I), F represents an organic group derived from a compound having a positive hole-transporting ability, R¹ and R² each independently represent a linear or branched alkylene group having 1 or more and 5 or less carbon atoms, n1 represents 0 or 1, and n2 represents an integer of 1 or greater and 4 or less. X represents —O—, —NH—, or —S—, and Y represents —OH, —OCH₃, —NH₂, —SH, or —COOH.

In General Formula (I), examples of the compound having a positive hole-transporting ability in the organic group derived from the compound having a positive hole-transporting ability represented by F include an arylamine derivative. Examples of the arylamine derivative include a triphenylamine derivative and a tetraphenylbenzidine derivative.

Further, it is preferable that the compound represented by General Formula (I) is, for example, a compound represented by General Formula (II). The compound represented by General Formula (II) is particularly excellent in charge mobility, stability to oxidation, and the like.

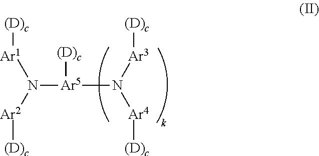

In General Formula (II), Ar¹ to Ar⁴ each independently represent a substituted or unsubstituted aryl group, Ar⁵ represents a substituted or unsubstituted aryl group or a substituted or unsubstituted arylene group, D represents —(—R₁—X)ₙ₁R₂—Y, c's each independently represent 0 or 1, k represents 0 or 1, and the total number of D's is 1 or more and 4 or less. Further, R₁ and R₂ each independently represent a linear or branched alkylene group having 1 or more and 5 or less carbon atoms, n1 represents 0 or 1, X represents —O—, —NH—, or —S—, and Y represents —OH, —OCH₃, —NH₂, —SH, or —COOH.

In General Formula (II), “—(—R₁—X)ₙ₁R₂—Y” represented by D has the same definition as that for General Formula (I), and R₁ and R₂ each independently represent a linear or branched alkylene group having 1 or more and 5 or less carbon atoms. Further, it is preferable that n1 represents, for example, 1. Further, it is preferable that X represents, for example, —O—. Further, it is preferable that Y represents, for example, —OH.

Further, the total number of D's in General Formula (II) corresponds to n2 in General Formula (I) and is, for example, preferably 2 or greater and 4 or less and more preferably 3 or greater and 4 or less. That is, in General Formula (I) and General Formula (II), in a case where the number of D's is set to, for example, preferably 2 or more and 4 or less and more preferably 3 or more and 4 or less in one molecule, the crosslinking density is increased, a crosslinked material with higher strength can be obtained, and thus surface abrasion of the electrophotographic photoreceptor is suppressed.

It is preferable that Ar¹ to Ar⁴ in General Formula (II) are, for example, represented by any of Formulae (1) to (7). Further, Formulae (1) to (7) are shown together with “-(D)_{c}” that can be linked to each of Ar¹ to Ar⁴.

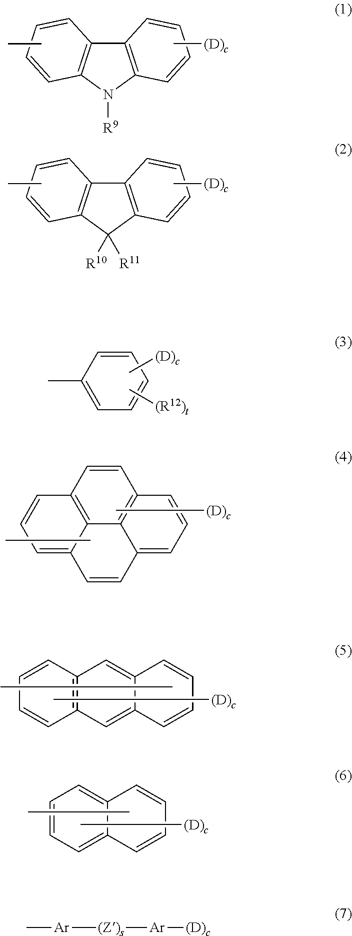

In Formulae (1) to (7), R⁹ represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, R¹⁰ to R¹² each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, Ar represents a substituted or unsubstituted arylene group, D and c each have the same definition as that for “D” and “c” in General Formula (II), s represents 0 or 1, and t represents an integer of 1 or greater and 3 or less.

Here, it is preferable that Ar in Formula (7) is, for example, represented by Formula (8) or (9).

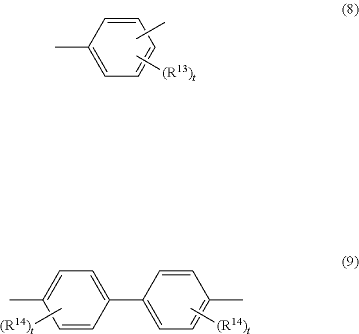

In Formulae (8) and (9), R¹³ and R¹⁴ each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, and t represents an integer of 1 or greater and 3 or less.

Further, it is preferable that Z′ in Formula (7) is, for example, represented by any of Formulae (10) to (17).

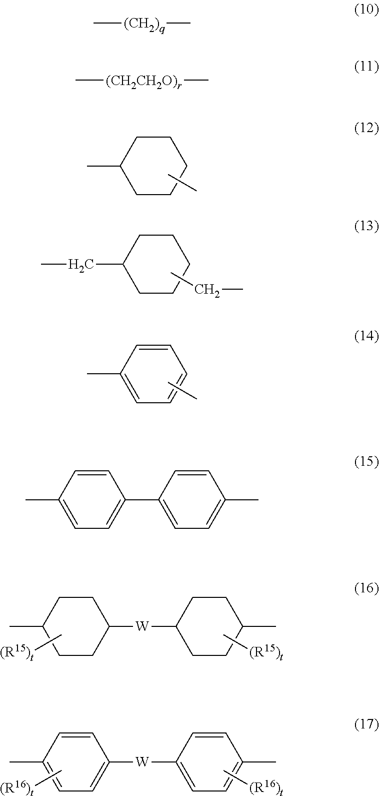

In Formulae (10) to (17), R¹⁵ and R¹⁶ each represents one selected from the group consisting of a hydrogen atom, an alkyl group having 1 or more and 4 or less carbon atoms, an alkoxy group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, W represents a divalent group, q and r each represents an integer of 1 or greater and 10 or less, and t's each represents an integer of 1 or greater and 3 or less.

It is preferable that W in Formulae (16) and (17) is, for example, represented by any of the divalent groups represented by Formulae (18) to (26). Here, in Formula (25), u represents an integer of 0 or greater and 3 or less.

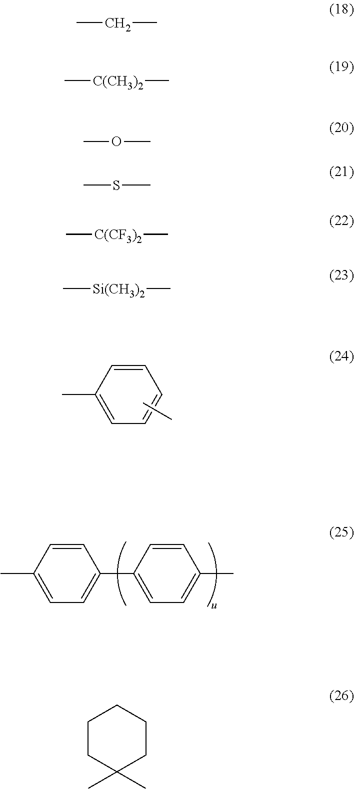

In General Formula (II), Ar⁵ represents an aryl group of Formulae (1) to (7) described in the section of Ar¹ to Ar⁴ in a case where k represents 0 and represents an arylene group obtained by removing a hydrogen atom from the aryl group of Formulae (1) to (7) in a case where k represents 1.

Specific examples of the compound represented by General Formula (I) include exemplary compounds: I-1 to I-31 shown below. Further, the compound represented by General Formula (I) is not limited thereto.

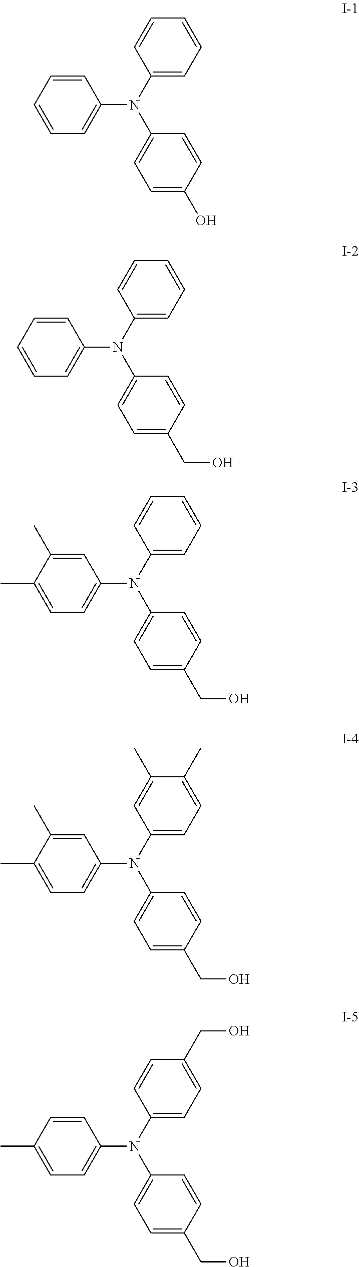

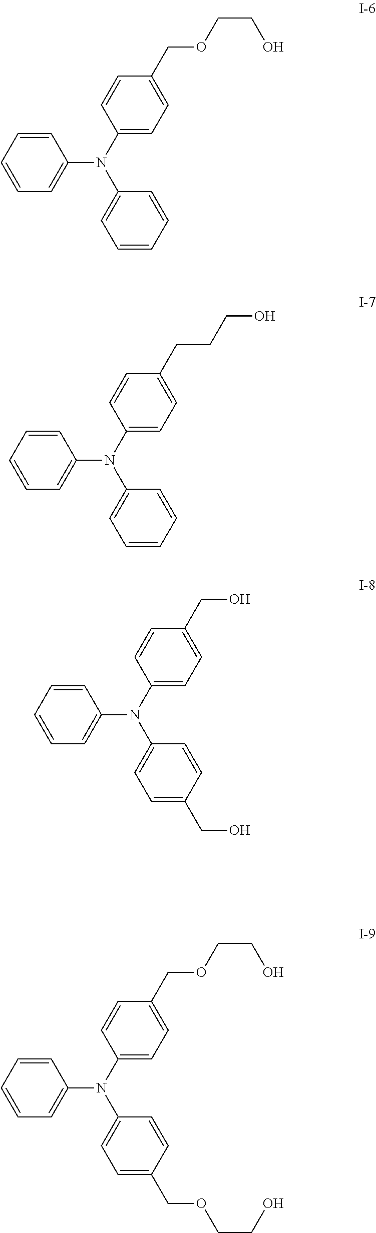

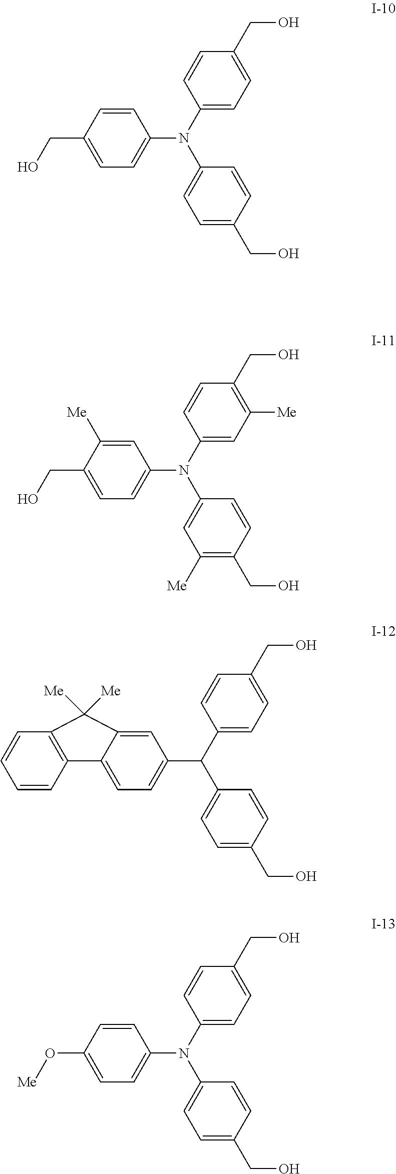

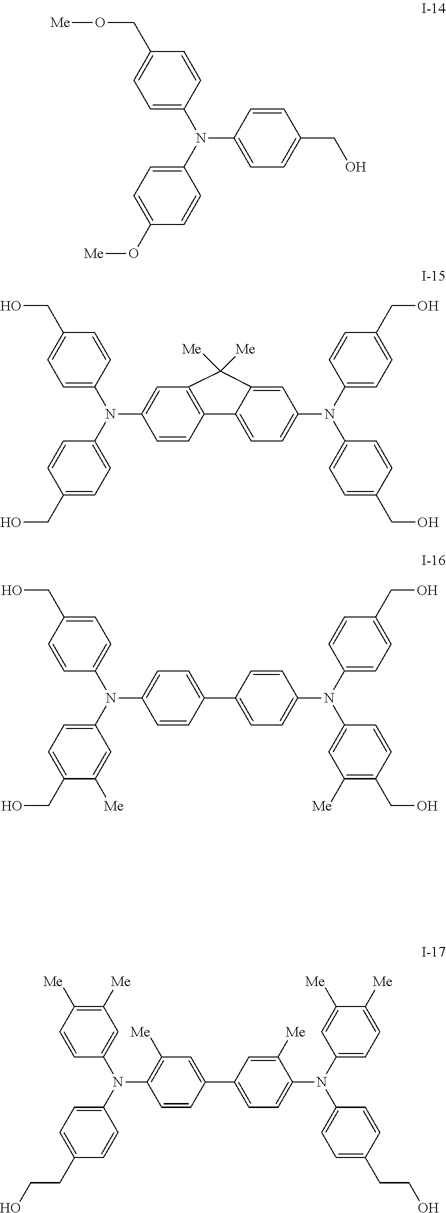

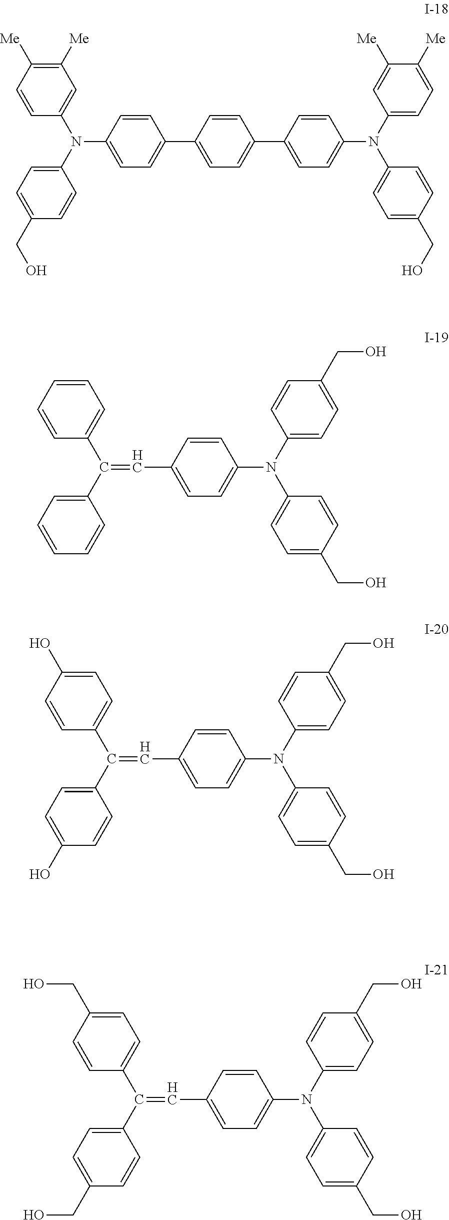

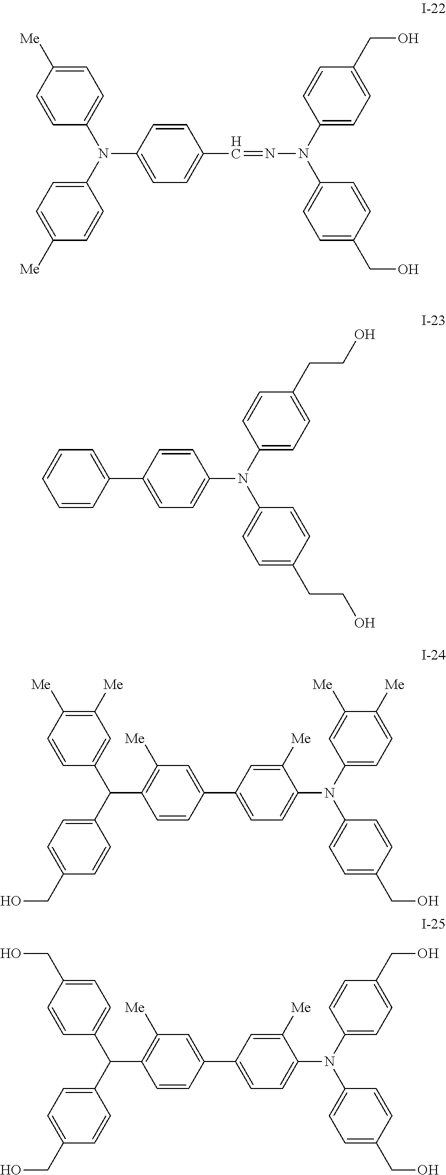

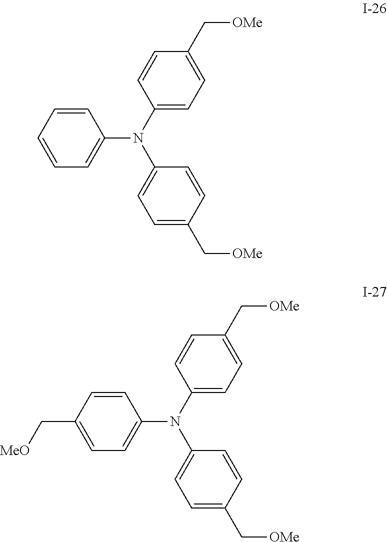

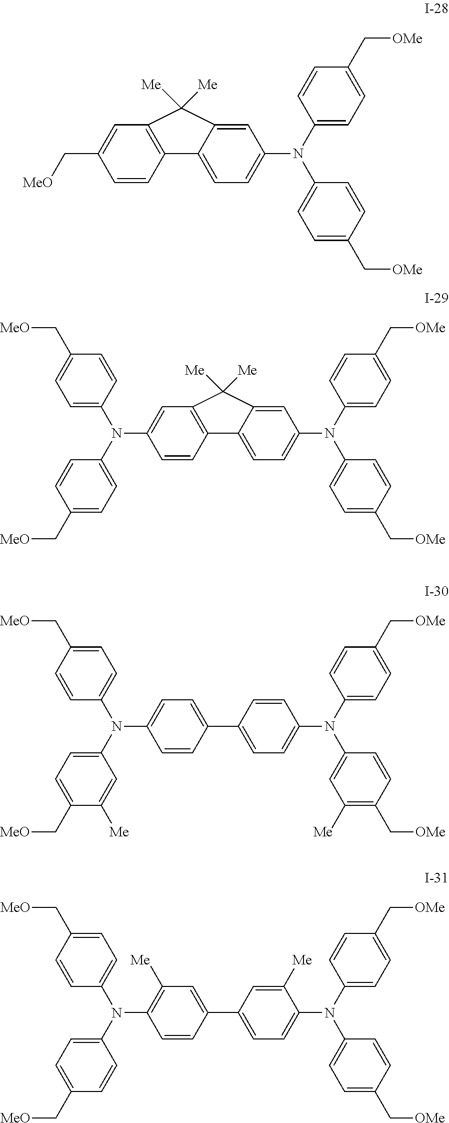

The total content of the compound X in the cured film (that is, the protective layer) is, for example, preferably 0.5% by mass or greater and 10.0% by mass or less, more preferably 1.5% by mass or greater and 8.0% by mass or less, still more preferably 2.0% by mass or greater and 8.0% by mass or less, and particularly preferably 2.5% by mass or greater and 5.0% by mass or less.

In a case where the total content of the compound X in the cured film is set to 0.5% by mass or greater, the water contact angle θ1 of the surface is easily adjusted to be in a range of 65° or greater and less than 80°. Further, in a case where the total content of the compound X in the cured film is set to 10.0% by mass or less, degradation of the electrical properties of the electrophotographic photoreceptor can be suppressed.

Further, the total content of the charge transport material Y in the cured film (that is, the protective layer) is, for example, preferably 85.0% by mass or greater and 99.5% by mass or less, more preferably 90.0% by mass or greater and 99.0% by mass or less, and still more preferably 94.0% by mass or greater and 98.0% by mass or less.

In a case where the total content of the charge transport material Y in the cured film is set to 85.0% by mass or greater, a high charge transport ability can be exhibited. Further, in a case where the total content of the charge transport material Y in the cured film is set to 99.5% by mass or less, the water contact angle θ1 of the surface is easily adjusted to be in a range of 65° or greater and less than 80°.

### Other Components

An oil such as silicone oil may be added to the protective layer as a leveling agent. Examples of the silicone oil include silicone oil such as dimethylpolysiloxane, diphenylpolysiloxane, and phenylmethylsiloxane; reactive silicone oil such as amino-modified polysiloxane, epoxy-modified polysiloxane, carboxyl-modified polysiloxane, carbinol-modified polysiloxane, methacryl-modified polysiloxane, mercapto-modified polysiloxane, and phenol-modified polysiloxane; cyclic dimethylcyclosiloxanes such as hexamethylcyclotrisiloxane, octamethylcyclotetrasiloxane, decamethylcyclopentasiloxane, and dodecamethylcyclohexasiloxane; cyclic methyl phenyl cyclosiloxanes such as 1,3,5-trimethyl-1,3,5-triphenylcyclotrisiloxane, 1,3,5,7-tetramethyl-1,3,5,7-tetraphenylcyclotetrasiloxane, and 1,3,5,7,9-pentamethyl-1,3,5,7,9-pentaphenylcyclopentasiloxane; cyclic phenyl cyclosiloxanes such as hexaphenylcyclotrisiloxane; fluorine-containing cyclosiloxanes such as (3,3,3-trifluoropropyl)methylcyclotrisiloxane; hydrosilyl group-containing cyclosiloxanes such as a methyl hydrosiloxane mixture, pentamethyl cyclopentasiloxane, and phenyl hydrocyclosiloxane; and vinyl group-containing cyclosiloxanes such as pentavinyl pentamethyl cyclopentasiloxane.

The protective layer may further contain resins such as a phenol resin, a melamine resin, a urea resin, an alkyd resin, and a benzoguanamine resin, various particles such as resin particles and conductive particles, a surfactant, a silane coupling agent, an antioxidant, and the like.

### Formation of Protective Layer

The protective layer is formed of a composition (coating solution for a protective layer) containing at least the compound X and the charge transport material Y. The coating solution for a protective layer may contain the above-described components in addition to the compound X and the charge transport material Y, as necessary.

The coating solution for a protective layer may be prepared without a solvent, or using a solvent such as alcohols such as methanol, ethanol, propanol, and butanol; ketones such as acetone and methyl ethyl ketone; and ethers such as tetrahydrofuran, diethyl ether, and dioxane, as necessary. Such a solvent may be used alone or in a mixture of two or more kinds thereof, and preferred examples thereof include a solvent having a boiling point of 100° C. or lower. As the solvent, for example, particularly a solvent containing at least one or more hydroxyl groups (for example, alcohols) may be used.

The amount of the solvent in the coating solution for a protective layer is optionally set, but the solvent is used in an amount of 0.5 parts by mass or greater and 30 parts by mass or less and, for example, preferably 1 part by mass or greater and 20 parts by mass or less with respect to 1 part by mass of the compound X from the viewpoint that the compound X is likely to precipitate.

The coating solution for a protective layer may contain a curing catalyst in order to promote curing of the compound X and the charge transporting compound Y. As the curing catalyst, for example, an acid-based catalyst is preferably used. Examples of the acid-based catalyst include aliphatic carboxylic acid such as acetic acid, chloroacetic acid, trichloroacetic acid, trifluoroacetic acid, oxalic acid, maleic acid, malonic acid, or lactic acid, aromatic carboxylic acid such as benzoic acid, phthalic acid, terephthalic acid, or trimellitic acid, aliphatic sulfonic acid such as methanesulfonic acid, dodecylsulfonic acid, benzenesulfonic acid, dodecylbenzenesulfonic acid, or naphthalenesulfonic acid, and aromatic sulfonic acid. Among these, for example, it is preferable to use a sulfur-containing material such as aliphatic sulfonic acid or aromatic sulfonic acid.

In a case where a sulfur-containing material is used as the curing catalyst, an excellent function as a curing catalyst is exhibited, and the mechanical strength of the protective layer obtained by promoting the curing reaction is further improved. Further, in a case where a compound represented by General Formula (I) (including General Formula (II)) is used as the charge transport material Y, the sulfur-containing material exhibits excellent functions as a dopant for these charge transport materials Y, and the electrical properties of the obtained functional layer are further improved. As a result, in a case where the electrophotographic photoreceptor is formed, all of the mechanical strength, the film-forming properties, and the electrical properties are achieved at high levels.

As the sulfur-containing material serving as a curing catalyst, for example, a material exhibiting acidity at room temperature (for example, 25° C.) or after being heated is preferable, and at least one of organic sulfonic acid or a derivative thereof is most preferable from the viewpoints of the adhesiveness, the ghosts, and the electrical properties. The presence of these catalysts in the protective layer is easily confirmed by XPS or the like.

Examples of the sulfur-containing material serving as a curing catalyst include paratoluene sulfonic acid, dinonylnaphthalene sulfonic acid (DNNSA), dinonylnaphthalene disulfonic acid (DNNDSA), dodecylbenzene sulfonic acid, and phenolsulfonic acid. Among these, for example, paratoluene sulfonic acid and dodecylbenzene sulfonic acid are preferable from the viewpoints of the catalytic ability and the film forming properties. Further, salts of the sulfonic acids described above may be used as long as the salts can be dissociated to some extent in the coating solution for a protective layer.

Further, a so-called thermal latent catalyst whose catalytic ability is increased in a case of being heated at a certain temperature or higher can also be used as the curing catalyst.

Examples of a commercially available product of the curing catalyst include “NACURE 2501” (toluene sulfonic acid dissociation, methanol/isopropanol solvent, pH of 6.0 or greater and 7.2 or less, dissociation temperature of 80° C.), “NACURE 2107” (p-toluene sulfonic acid dissociation, isopropanol solvent, pH of 8.0 or greater and 9.0 or less, dissociation temperature of 90° C.), “NACURE 2500” (p-toluene sulfonic acid dissociation, isopropanol solvent, pH of 6.0 or greater and 7.0 or less, dissociation temperature of 65° C.), “NACURE 2530” (p-toluene sulfonic acid dissociation, methanol/isopropanol solvent, pH of 5.7 or greater and 6.5 or less, dissociation temperature of 65° C.), “NACURE 2547” (p-toluene sulfonic acid dissociation, aqueous solution, pH of 8.0 or greater and 9.0 or less, dissociation temperature of 107° C.), “NACURE 2558” (p-toluene sulfonic acid dissociation, ethylene glycol solvent, pH of 3.5 or greater and 4.5 or less, dissociation temperature of 80° C.), “NACURE XP-357” (p-toluene sulfonic acid dissociation, methanol solvent, pH of 2.0 or greater and 4.0 or less, dissociation temperature of 65° C.), “NACURE XP-386” (p-toluene sulfonic acid dissociation, aqueous solution, pH of 6.1 or greater and 6.4 or less, dissociation temperature of 80° C.), “NACURE XC-2211” (p-toluene sulfonic acid dissociation, pH of 7.2 or greater and 8.5 or less, dissociation temperature of 80° C.), “NACURE 5225” (dodecylbenzene sulfonic acid dissociation, isopropanol solvent, pH of 6.0 or greater and 7.0 or less, dissociation temperature of 120° C.), “NACURE 5414” (dodecylbenzene sulfonic acid dissociation, xylene solvent, dissociation temperature of 120° C.), “NACURE 5528” (dodecylbenzene sulfonic acid dissociation, isopropanol solvent, pH of 7.0 or greater and 8.0 or less, dissociation temperature of 120° C.), “NACURE 5925” (dodecylbenzene sulfonic acid dissociation, pH of 7.0 or greater and 7.5 or less, dissociation temperature of 130° C.), “NACURE 1323” (dinonylnaphthalene sulfonic acid dissociation, xylene solvent, pH of 6.8 or greater and 7.5 or less, dissociation temperature of 150° C.), “NACURE 1419” (dinonylnaphthalene sulfonic acid dissociation, xylene/methyl isobutyl ketone solvent, dissociation temperature of 150° C.), “NACURE 1557” (dinonylnaphthalene sulfonic acid dissociation, butanol/2-butoxy ethanol solvent, pH of 6.5 or greater and 7.5 or less, dissociation temperature of 150° C.), “NACURE X49-110” (dinonylnaphthalene disulfonic acid dissociation, isobutanol/isopropanol solvent, pH of 6.5 or greater and 7.5 or less, dissociation temperature of 90° C.), “NACURE 3525” (dinonylnaphthalene disulfonic acid dissociation, isobutanol/isopropanol solvent, pH of 7.0 or greater and 8.5 or less, dissociation temperature of 120° C.), “NACURE XP-383” (dinonylnaphthalene disulfonic acid dissociation, xylene solvent, dissociation temperature of 120° C.), “NACURE 3327” (dinonylnaphthalene disulfonic acid dissociation, isobutanol/isopropanol solvent, pH of 6.5 or greater and 7.5 or less, dissociation temperature of 150° C.), “NACURE 4167” (phosphoric acid dissociation, isopropanol/isobutanol solvent, pH of 6.8 or greater and 7.3 or less, dissociation temperature of 80° C.), “NACURE XP-297” (phosphoric acid dissociation, water/isopropanol solvent, pH of 6.5 or greater and 7.5 or less, dissociation temperature of 90° C.), and “NACURE 4575” (phosphoric acid dissociation, pH of 7.0 or greater and 8.0 or less, dissociation temperature of 110° C.) (all manufactured by King Industries, Inc.).

These curing catalysts are used alone or in combination of two or more kinds thereof.

Here, the blending amount of the curing catalyst is, for example, preferably 0.1% by mass or greater and 50% by mass or less and particularly preferably 10% by mass or greater and 30% by mass or less with respect to the amount of the compound X (solid content concentration in the coating solution for a protective layer).

Further, in a case of obtaining the coating solution for a protective layer, each of the above-described components may be simply mixed and dissolved, but may be heated at room temperature (for example, 25° C.) or higher and 100° C. or lower and, for example, preferably 30° C. or higher and 80° C. or lower for 10 minutes or longer and 100 hours or shorter and preferably 1 hour or longer and 50 hours or shorter. Further, it is also preferable that the components are, for example, irradiated with ultrasonic waves in this case.

Further, a protective layer formed of a cured film can be obtained by coating a photosensitive layer (specifically, for example, a charge transport layer) with the coating solution for a protective layer using a typical coating method such as a blade coating method, a wire bar coating method, a spray coating method, a dip coating method, a bead coating method, an air knife coating method, or a curtain coating method and, for example, heating the layer at a temperature of 100° C. or higher and 170° C. or lower so that the layer is cured, as necessary.

The film thickness of the protective layer is set to be, for example, preferably in a range of 15 μm or greater and 25 μm or less and more preferably in a range of 18 μm or greater and 22 μm or less.

### Charging Member

The charging member of the process cartridge according to the present exemplary embodiment will be described.

The charging member in the present exemplary embodiment is a charging member that includes an elastic layer and a surface layer on a conductive base material in this order and comes into contact with the electrophotographic photoreceptor to charge the surface of the electrophotographic photoreceptor. The shape of the charging member is not limited as long as the charging member has the above-described layer configuration, and examples thereof include a roll shape, a belt shape, a tube shape, and a blade shape. Among these, for example, a roll shape is preferable.

The layer configuration of the charging member will be described with reference to FIG. 2.

As shown in FIG. 2, for example, a charging member 30 is a roll member including a conductive base material 32, an elastic layer 34 provided on the outer peripheral surface of the conductive base material 32, and a surface layer 36 provided on the outer peripheral surface of the elastic layer 34. Further, for example, an adhesive layer (not shown) may be provided between the conductive base material 32 and the elastic layer 34.

The charging member in the present exemplary embodiment is a charging member including an elastic layer and a surface layer on a conductive base material in this order and comes into contact with the electrophotographic photoreceptor to charge the surface of the electrophotographic photoreceptor. Further, the water contact angle θ2 of the surface of the charging member satisfies the relationship of θ1<θ2.

Further, the charging member may include an adhesive layer between the conductive base material and the elastic layer.

### Conductive Base Material

The conductive base material functions as an electrode of the charging member and a support member. Examples of the material of the conductive base material include metals such as iron (free-cutting steel or the like), copper, brass, stainless steel, aluminum, and nickel or alloys thereof; and iron subjected to a plating treatment with chromium, nickel, or the like. Examples of the support include a member (for example, a resin or a ceramic member) obtained by performing a plating treatment on the outer peripheral surface thereof and a member (for example, a resin or a ceramic member) in which a conductive agent is dispersed. The support may be a hollow member (cylindrical member) or a non-hollow member.

### Elastic Layer

The elastic layer contains an elastic material and a conductive agent. The elastic layer may contain other additives as necessary. Further, the elastic layer may also serve as, for example, a resistance adjusting layer.

Examples of the elastic material include isoprene rubber, chloroprene rubber, epichlorohydrin rubber, butyl rubber, urethane rubber, silicone rubber, fluororubber, styrene-butadiene rubber, butadiene rubber, nitrile rubber, ethylene propylene rubber, epichlorohydrin-ethylene oxide copolymer rubber, epichlorohydrin-ethylene oxide-allyl glycidyl ether copolymer rubber, ethylene-propylene-diene copolymer rubber, acrylonitrile-butadiene copolymer rubber, natural rubber, and rubber obtained by mixing these rubbers.

Among these elastic materials, for example, silicone rubber, ethylene propylene rubber, epichlorohydrin-ethylene oxide copolymer rubber, epichlorohydrin-ethylene oxide-allyl glycidyl ether copolymer rubber, and rubber obtained by mixing these rubbers are preferable. The rubber materials may be foamed or non-foamed.

Examples of the conductive agent include an electron conductive substance and an ion conductive substance.

Examples of the electron conductive substance include carbon black such as Ketjen black or acetylene black, pyrolytic carbon, a metal such as graphite, zinc, aluminum, copper, iron, nickel, chromium, or titanium, and a known metal oxide such as ZnO—Al₂O₃, SnO₂—Sb₂O₃, In₂O₃—SnO₂, ZnO—TiO₂, MgO—Al₂O₃, FeO—TiO₂, TiO₂, SnO₂, Sb₂O₃, In₂O₃, ZnO, or MgO.

Examples of the ion conductive substance include known salts such as a quaternary ammonium salt, a perchlorate of an alkali metal, and a perchlorate of an alkaline earth metal.

These conductive agents may be used alone or in combination of two or more kinds thereof.

The content of the conductive agent is not particularly limited as long as the content thereof is in a range where target properties of the elastic layer can be obtained.

Specifically, in a case of the electron conductive substance, the content of the conductive agent is, for example, preferably 1 part by mass or greater and 90 parts by mass or less with respect to 100 parts by mass of the elastic material.

Meanwhile, in a case of the ion conductive substance, the content of the conductive agent is, for example, preferably 0.01 parts by mass or greater and 10 parts by mass or less with respect to 100 parts by mass of the elastic material.

Examples of other additives in the elastic layer include known additives such as a softening agent, a plasticizer, a vulcanizing agent, a vulcanization accelerator, an antioxidant, a surfactant, and a coupling agent.

In a case where the elastic layer also serves as a resistance adjusting layer, the volume resistivity of the elastic layer may be, for example, 10³ Ωcm or greater and 10¹⁴ Ωcm or less, and is preferably 10⁵ Ωcm or greater and 10¹² Ωcm or less and more preferably 10⁷ Ωcm or greater and 10¹² Ωcm or less.

The volume resistivity of the elastic layer is a value measured by the method described below.

That is, a sheet-like measurement sample is collected from the elastic layer. A voltage adjusted such that an electric field (applied voltage/composition sheet thickness) reaches 1000 V/cm is applied to the measurement sample for 30 seconds by using a measuring jig (R12702A/B resistivity chamber: manufactured by Advantest Corporation) and a high resistance meter (R8340A digital high resistance/micro ammeter: manufactured by Advantest Corporation) in conformity with JIS K 6911 (1995), and the volume resistivity is calculated from a flowing current value according to the following equation.

$$Volume resistivity ( Ω cm ) = ( 19.63 \times applied voltage ( V ) ) / ( current value ( A ) \times measurement sample thickness ( cm ) )$$

The thickness of the elastic layer varies depending on an apparatus to which the charging member is applied, and may be, for example, 1 mm or greater and 10 mm or less and is preferably 2 mm or greater and 5 mm or less.

The thickness of the elastic layer is a value measured by the following method.

That is, the elastic layer (charging member) is cut at three sites, positions spaced by 20 mm from both ends in the axial direction and the central portion, with a single-edged knife, cross sections of the cut samples are observed at an appropriate magnification of 5 to 50 times according to the thicknesses, the film thicknesses are measured, and the average value thereof is defined as the thickness of the elastic layer. As a measuring device, a digital microscope VHX-200 (manufactured by Keyence Corporation) is used.

### Surface Layer

The surface layer may be provided in an aspect in which a resin layer is independently provided on the elastic layer or in an aspect in which air bubbles in a surface layer portion of the foamed elastic layer are impregnated with a resin or the like (that is, an aspect in which the surface layer portion of the elastic layer obtained by impregnating air bubbles with a resin or the like is used as a surface layer).

Further, since the surface layer of the charging member forms the surface of the charging member, the water contact angle θ2 of the surface of the surface layer is set to satisfy the relationship of θ1<θ2.

The water contact angle of the surface of the surface layer, that is, the water contact angle θ2 of the surface of the charging member may satisfy the relationship of θ1<θ2. From the viewpoint of suppressing streak-like image defects, the water contact angle θ2 of the surface of the charging member is, for example, preferably greater than 65° and 90° or less.

Examples of a means of adjusting the water contact angle θ2 to be in the above-described range include adjustment of the kind of resin contained in the surface layer, adjustment of the content, and adjustment of the sea-island structure formed on the surface layer.

From the viewpoint of adjusting the water contact angle θ2 of the surface of the charging member and from the viewpoint of suppressing streak-like image defects, for example, it is preferable that the surface layer has a sea-island structure on the surface.

In particular, from the viewpoint of adjusting the water contact angle θ2 of the surface of the charging member and from the viewpoint of suppressing streak-like image defects, the proportion of the area of the island portion in the area of the sea portion in the sea-island structure is, for example, preferably 0.21 or greater and 0.72 or less.

From the same viewpoints described above, the diameter of the island portion in the sea-island structure is, for example, preferably 0.2 μm or greater and 1.5 μm or less (for example, more preferably 0.3 μm or greater and 1.0 μm or less).

Here, a method of confirming the sea-island structure on the surface of the surface layer, a method of measuring the proportion of the area of the island portion in the area of the sea portion, and a method of measuring the diameter of the island portion are as follows.

First, a small piece is cut out from the surface layer of the charging member with a single-edged knife to prepare a sample.

Next, a secondary electron image of the surface of the surface layer is imaged with a scanning electron microscope (JSM-6700F, manufactured by JEOL, Ltd.) on the small piece sample at an acceleration voltage of 5 kV and a magnification of 5000 times.

This image is taken in an image analyzer (LUZEXIII, manufactured by Nireco Corporation). Further, the maximum diameter of the island portion in the image is measured by image analysis, and the arithmetic average value thereof is defined as the diameter of the island portion.

Examples of the material for forming the surface layer include a resin.

Examples of the resin include an acrylic resin, a fluorine-modified acrylic resin, a silicone-modified acrylic resin, a cellulose resin, a polyamide resin (including copolymer nylon), a polyurethane resin, a polycarbonate resin, a polyester resin, a polyimide resin, an epoxy resin, a silicone resin, a polyvinyl alcohol resin, a polyvinyl butyral resin, a polyvinyl acetal resin, an ethylene tetrafluoroethylene resin, a melamine resin, a polyethylene resin, a polyvinyl resin, a polyarylate resin, a polythiophene resin, a polyethylene terephthalate resin (PET), and a fluororesin (such as a polyvinylidene fluoride resin, a tetrafluoroethylene resin, a tetrafluoroethylene-perfluoroalkyl vinyl ether copolymer (PFA), or a tetrafluoroethylene-hexafluoropropylene copolymer (FEP)). Further, for example, a resin obtained by curing or crosslinking a curable resin using a curing agent or a catalyst is preferable as the resin.

Here, the copolymer nylon is a copolymer having any one or a plurality of kinds of 610 nylon, 11 nylon, and 12 nylon, as a polymerization unit. Further, the copolymer nylon may have other polymerization units such as 6 nylon and 66 nylon.

Among these, from the viewpoint of obtaining the above-described sea-island structure, for example, it is preferable to use, as the resin, two or more of a polyamide resin, a polyvinyl alcohol resin, a polycarbonate resin, and an acrylic resin in combination and particularly preferable to use a polyamide resin and a polyvinyl alcohol resin in combination.

In particular, from the viewpoint of the abrasion resistance of the surface layer, for example, alkoxymethylated polyamide (alkoxymethylated nylon) is preferable, and methoxymethylated polyamide (N-methoxymethylated nylon) is more preferable as the polyamide resin.

Further, the resin may have a crosslinked structure from the viewpoint of improving the mechanical strength of the surface layer and suppressing occurrence of cracks in the surface layer.

Examples of other materials for forming the surface layer include known additives that can be added to a typical surface layer, such as a conductive agent such as carbon black, a filler, a curing agent, a vulcanizing agent, a vulcanization accelerator, an antioxidant, a surfactant, and a coupling agent.

The volume resistivity of the surface layer may be, for example, 10³ Ωcm or greater and 10¹⁴ Ωcm or less, and is preferably 10⁵ Ωcm or greater and 10¹² Ωcm or less and more preferably 10⁷ Ωcm or greater and 10¹² Ωcm or less.

The volume resistivity of the surface layer is a value measured by the following method. That is, a flat plate of a metal such as aluminum or stainless steel, or a sheet-like rubber material having a volume resistivity of 10 Ωcm or less is coated with the surface layer to obtain a measurement sample. A voltage adjusted such that an electric field (applied voltage/composition sheet thickness) reaches 1000 V/cm is applied to the measurement sample for 30 seconds by using a measuring jig (R12702A/B resistivity chamber: manufactured by Advantest Corporation) and a high resistance meter (R8340A digital high resistance/micro ammeter: manufactured by Advantest Corporation) in conformity with JIS K 6911 (1995), and the volume resistivity is calculated from a flowing current value according to the following equation.

$$Volume resistivity ( Ω cm ) = ( 19.63 \times applied voltage ( V ) ) / ( current value ( A ) \times measurement sample thickness ( cm ) )$$

From the viewpoint of suppressing movement of a bleed substance (that is, a liquid substance that bleeds) and a bloom substance (that is, a solid substance that precipitates) from the elastic layer to the surface of the charging member and from the viewpoint of the resistance stability of the surface layer, the thickness of the surface layer may be, for example, 2 μm or greater and 25 μm or less, and is preferably 3 μm or greater and 20 μm or less, more preferably 3 μm or greater and 15 μm or less, and still more preferably 5 μm or greater and 15 μm or less.

The thickness of the surface layer is a value measured by the following method.

That is, the surface layer (charging member) is cut at three sites, positions spaced by 20 mm from both ends in the axial direction and the central portion, with a single-edged knife, cross sections of the cut samples are observed at a magnification of 1000 times, the film thicknesses are measured, and the average value thereof is defined as the thickness of the surface layer. As a measuring device, a digital microscope VHX-200 (manufactured by Keyence Corporation) is used.

The surface layer is formed, for example, by dispersing each component in a solvent to prepare a coating solution, coating the elastic layer formed in advance with the coating solution, and heating the layer.

Examples of a method of coating the layer with the coating solution include a blade coating method, a wire bar coating method, a spray coating method, a dip coating method, a bead coating method, an air knife coating method, a curtain coating method, a flow coating method, a ring coating method, a die coating method, and an ink jet coating method.

The solvent used in the coating solution is not particularly limited, and general solvents are used, and solvents, for example, alcohols such as methanol, ethanol, propanol, and butanol; ketones such as acetone and methyl ethyl ketone; tetrahydrofuran; ethers such as diethyl ether, and dioxane may be used. Further, various solvents other than the solvents described above may be used, and from the viewpoint of applying a dip coating method, an alcohol solvent, a ketone solvent, or a mixed solvent thereof may be used.

### Image Forming Apparatus

An image forming apparatus according to the present exemplary embodiment is an image forming apparatus including an electrophotographic photoreceptor that includes a photosensitive layer and a protective layer on a conductive substrate in this order, a charging member that includes an elastic layer and a surface layer on a conductive base material in this order and comes into contact with the electrophotographic photoreceptor to charge a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image formed on the surface of the electrophotographic photoreceptor to a surface of a recording medium, in which the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, the water contact angle θ1 of the surface is 65° or greater and less than 80°, and the water contact angle θ2 of the surface of the charging member satisfies a relationship of θ1<θ2.

The image forming apparatus according to the present exemplary embodiment includes the electrophotographic photoreceptor and the charging member in the process cartridge according to the present exemplary embodiment as described above.

As the image forming apparatus according to the present exemplary embodiment, a known image forming apparatus such as an apparatus including a fixing means that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning means that cleans the surface of the electrophotographic photoreceptor after the transfer of the toner image and before the charging; an apparatus including a destaticizing means that destaticizes the surface of the electrophotographic photoreceptor by irradiating the surface with destaticizing light after the transfer of the toner image and before the charging; or an apparatus including an electrophotographic photoreceptor heating member for increasing the temperature of the electrophotographic photoreceptor and decreasing the relative temperature is employed.

In a case of the intermediate transfer type apparatus, the transfer means is, for example, configured to include an intermediate transfer member having a surface onto which the toner image is transferred, a primary transfer means primarily transferring the toner image formed on the surface of the electrophotographic photoreceptor to the surface of the intermediate transfer member, and a secondary transfer means secondarily transferring the toner image transferred to the surface of the intermediate transfer member to the surface of the recording medium.

Further, in the image forming apparatus according to the present exemplary embodiment, for example, the portion including the electrophotographic photoreceptor and the charging member may have a cartridge structure (process cartridge according to the present exemplary embodiment) that is attachable to and detachable from the image forming apparatus. The process cartridge may include, for example, at least one selected from the group consisting of an electrostatic latent image forming device, a developing device, and a transfer device in addition to the electrophotographic photoreceptor and the charging member.

Hereinafter, an example of the image forming apparatus according to the present exemplary embodiment will be described, but the present exemplary embodiment is not limited thereto. Further, main parts shown in the figures will be described, but description of other parts will not be provided.

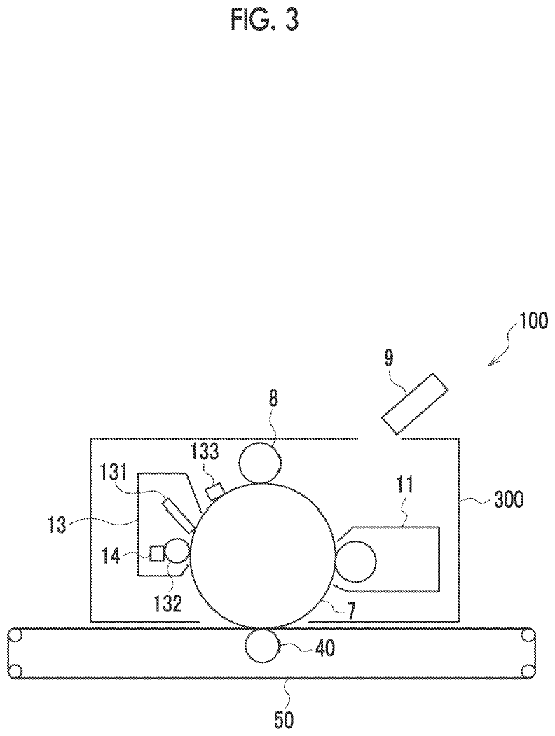

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. Further, in the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). Further, the intermediate transfer member 50, the transfer device 40 (primary transfer device), and the secondary transfer device (not shown) correspond to an example of the transfer means.

The process cartridge 300 in FIG. 3 integrally supports the electrophotographic photoreceptor 7, a charging device 8 (an example of the charging means), a developing device 11 (an example of the developing means), and a cleaning device 13 (an example of the cleaning means) in a housing. The cleaning device 13 has a cleaning blade (an example of the cleaning member) 131, and the cleaning blade 131 is disposed to come into contact with the surface of the electrophotographic photoreceptor 7. Further, the cleaning member may be a conductive or insulating fibrous member instead of the aspect of the cleaning blade 131, and may be used alone or in combination with the cleaning blade 131.

Further, FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, the charging member in the process cartridge according to the present exemplary embodiment described above is employed.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of 600 nm level or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used.

In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, or a rubber blade, a scorotron transfer charger, or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

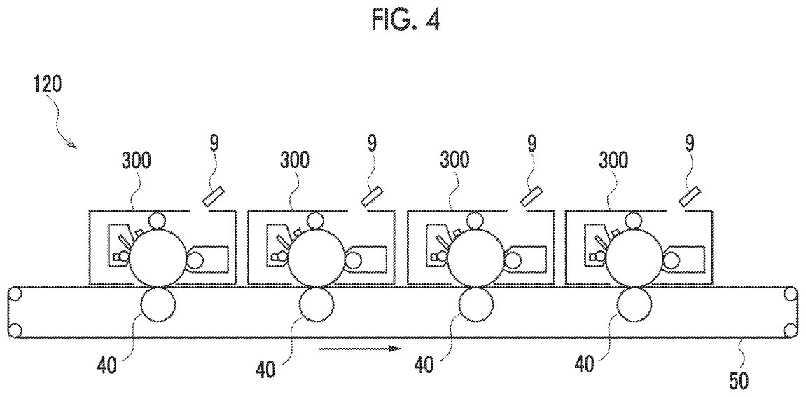

FIG. 4 is a schematic configuration view showing an example of an image forming apparatus according to the present exemplary embodiment.

An image forming apparatus 120 shown in FIG. 4 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. Further, the image forming apparatus 120 has the same configuration as the image forming apparatus 100 except that the image forming apparatus 120 is of a tandem type.

### EXAMPLES

Hereinafter, the present invention will be described based on examples, but the present invention is not limited to these examples. Further, in the following description, “parts” denotes “parts by mass”.

### Preparation of Photoreceptor

### Preparation of Photoreceptor 1

### Formation of Undercoat Layer

100 parts by mass of zinc oxide (manufactured by Tayca Corporation, average particle diameter of 70 nm, specific surface area of 15 m²/g) is stirred and mixed with 500 parts by mass of tetrahydrofuran, 1.25 parts by mass of KBM603 (manufactured by Shin-Etsu Chemical Co., Ltd.) is added thereto as a silane coupling agent, and the mixture is stirred for 2 hours. Thereafter, tetrahydrofuran is distilled off by vacuum distillation and baked at 120° C. for 3 hours to obtain zinc oxide particles surface-treated with a silane coupling agent.

A mixed solution is obtained by mixing 60 parts by mass of the zinc oxide particles subjected to a surface treatment, 0.6 parts by mass of alizarin, 13.5 parts by mass of blocked isocyanate (SUMIDUR 3173, manufactured by Sumitomo Bayer Urethane Co., Ltd.) as a curing agent, 15 parts by mass of a butyral resin (S-LEC BM-1, manufactured by Sekisui Chemical Co., Ltd.), and 85 parts by mass of methyl ethyl ketone. 38 parts by mass of this mixed solution and 25 parts by mass of methyl ethyl ketone are mixed and dispersed for 4 hours in a sand mill using glass beads having a diameter of 1 mm, thereby obtaining a dispersion liquid. 0.005 part by mass of dioctyltin dilaurate as a catalyst and 4.0 parts by mass of silicone resin particles (TOSPEARL 145, manufactured by Momentive Performance Materials Inc.) are added to the obtained dispersion liquid, thereby obtaining a coating solution for an undercoat layer.

An aluminum base material having a diameter of 30 mm is coated with the coating solution by a dip coating method, and dried and cured at 180° C. for 40 minutes, thereby obtaining an undercoat layer having a thickness of 25 μm.

### Formation of Charge Generation Layer

Next, a mixture of 15 parts by mass of chlorogallium phthalocyanine crystals having strong diffraction peaks where Bragg angles (2θ±0.2°) with respect to Cukα characteristic X-rays are at least 7.4°, 16.6°, 25.5°, and 28.3°, 10 parts by mass of a vinyl chloride-vinyl acetate copolymer resin (VMCH, Nippon Unicar Company Limited), and 300 parts by mass of n-butyl alcohol as charge generation materials is dispersed in a sand mill for 4 hours using glass beads having a diameter of 1 mm, thereby obtaining a coating solution for a charge generation layer.

The undercoat layer is immersed in and coated with the coating solution for a charge generation layer, and dried at 120° C. for 5 minutes, thereby obtaining a charge generation layer having a thickness of 0.2 μm.

### Formation of Charge Transport Layer

Subsequently, 42 parts by mass of N,N′-bis(3-methylphenyl)-N,N′-diphenylbenzidine and 58 parts by mass of a bisphenol Z polycarbonate resin (TS2050, viscosity average molecular weight of 50,000, manufactured by Teijin Chemicals Ltd.) are sufficiently dissolved and mixed in 280 parts by mass of tetrahydrofuran and 120 parts by mass of toluene, thereby obtaining a coating solution for a charge transport layer.

The aluminum support on which the charge generation layer is formed is immersed in and coated with the coating solution for a charge transport layer, and dried at 135° C. for 40 minutes, thereby forming a charge transport layer having a film thickness of 20 μm.

### Formation of Protective Layer

Next, 45 parts by mass of the compound I-16 serving as the charge transport material Y described above, 52 parts by mass of the compound I-8, and 2 parts by mass of a methylated melamine resin serving as the compound X (B-2: NIKALAC MW-30HM, manufactured by Sanwa Chemical Co., Ltd.) are dissolved in 50 parts by mass of isopropyl alcohol and 50 parts by mass of 2-butanol, and 0.1 parts of dimethylpolysiloxane (GLANOL 450, manufactured by Kyoeisha Chemical Co., Ltd.) which is a leveling agent and 0.01 parts of NACURE 2500 (King Industries, Inc.) which is a curing catalyst are added to solution, thereby preparing a coating solution for a protective layer.

The aluminum base material on which the charge transport layer is formed is coated with the obtained coating solution for a protective layer by a dip coating method, and heated and dried under conditions of 150° C. for 40 minutes, thereby forming a protective layer having a film thickness of 6 μm.

In this manner, a photoreceptor 1 having a surface with a water contact angle θ1 of 74° is obtained.

### Preparation of Photoreceptor 2

A photoreceptor 2 having a surface with a water contact angle θ1 of 72° is obtained in the same manner as in the preparation of the photoreceptor 1 except that the methylated melamine resin used for formation of the surface layer is changed to a benzoguanamine resin (NIKALAC BL-60, manufactured by Sanwa Chemical Co., Ltd.) serving as the compound X.

### Preparation of Photoreceptor 3

A photoreceptor 3 having a surface with a water contact angle θ1 of 65° is obtained in the same manner as in the preparation of the photoreceptor 1 except that the methylated melamine resin used for formation of the surface layer is changed to 2.5 parts by mass of a benzoguanamine resin (NIKALAC BL-60, manufactured by Sanwa Chemical Co., Ltd.) serving as the compound X, and further, 52 parts by mass of the compound I-8 is changed to 50 parts by mass of the compound I-10 which is the charge transport material Y.

### Preparation of Photoreceptor 4

A photoreceptor 4 having a surface with a water contact angle θ1 of 65° is obtained in the same manner as in the preparation of the photoreceptor 1 except that the methylated melamine resin used for formation of the surface layer is changed to 2.5 parts by mass of a benzoguanamine resin (NIKALAC BL-60, manufactured by Sanwa Chemical Co., Ltd.) serving as the compound X, and further, the heating and drying at 150° C. in formation of the surface layer is changed to the heating and drying at 145° C.

### Preparation of Photoreceptor 5

A photoreceptor 5 having a surface with a water contact angle θ1 of 64° is obtained in the same manner as in the preparation of the photoreceptor 4 except that the heating and drying at 145° C. in the formation of the surface layer is changed to the heating and drying at 140° C.

### Preparation of Photoreceptor 6

A photoreceptor 6 having a surface with a water contact angle θ1 of 80° is obtained in the same manner as in the preparation of the photoreceptor 1 except that the methylated melamine resin used for formation of the surface layer is changed to a benzoguanamine resin (NIKALAC BL-60, manufactured by Sanwa Chemical Co., Ltd.) serving as the compound X, and further, the heating and drying at 150° C. in formation of the surface layer is changed to the heating and drying at 160° C.

### Preparation of Photoreceptor 7

A photoreceptor 7 having a surface with a water contact angle θ1 of 95° is obtained by preparing the charge generation layer using the same method as in Example 1 and forming the charge transport layer using the following method.

Further, the photoreceptor 7 has a charge transport layer as a surface layer and does not have a protective layer formed therein.

### Formation of Charge Transport Layer

A liquid obtained by sufficiently dissolving and mixing 42 parts by mass of N,N′-bis(3-methylphenyl)-N,N′-diphenylbenzidine and 58 parts by mass of a bisphenol Z polycarbonate resin (TS2050: viscosity average molecular weight of 50,000, manufactured by Teijin Chemicals Ltd.) in 280 parts by mass of tetrahydrofuran and 120 parts by mass of toluene is mixed with a mixed solution of 0.02 parts by mass of a fluorine-based comb-type graft polymer (trade name, GF300, manufactured by Toagosei Co., Ltd.), 5 parts by mass of polytetrafluoroethylene particles (trade name, LUBRON L2, Daikin Industries, Ltd.) and 20 parts by mass of THF, and the solution is subjected to a dispersion treatment using a collision type high-pressure disperser (trade name, NANOMIZER, manufactured by Yoshida Kikai Co., Ltd.), thereby obtaining a coating solution for a charge transport layer.

The aluminum support on which the charge generation layer is formed is immersed in and coated with the coating solution for a charge transport layer, and dried at 135° C. for 40 minutes, thereby forming a charge transport layer having a film thickness of 20 μm.

### Preparation of Charging Member (Charging Roll)

### Preparation of Charging Roller 1

### Formation of Elastic Layer

Epichlorohydrin rubber (Gechron 3106, manufactured by Zeon Corporation): 100 parts by mass
Carbon black (Asahi #60, manufactured by Asahi Carbon Co., Ltd.): 6 parts by mass
Calcium carbonate (WHITON SB, manufactured by Shiraishi Calcium Kaisha, Ltd.): 20 parts by mass
Ionic conductive agent (BTEAC, manufactured by Lion Corporation): 5 parts by mass
Vulcanization accelerator: stearic acid (manufactured by NOF Corporation): 1 part by mass
Vulcanizing agent: sulfur (VULNOC R, manufactured by Ouchi Shinko Chemical Industrial Co., Ltd.): 1 part by mass
Vulcanization accelerator: zinc oxide: 1.5 parts by mass

The mixture having the composition described above is kneaded with an open roll. A roll-like elastic layer having a diameter of 15 mm is formed using the obtained mixture on a surface of a metal shaft (conductive base material) formed by SUS303 and having a diameter of 8 mm via an adhesive layer using a press molding machine. Thereafter, a conductive elastic roll A having a diameter of 14 mm is obtained by polishing the elastic layer.

### Formation of Surface Layer

Binder resin: N-methoxymethylated nylon (trade name: F30K, manufactured by Nagase ChemteX Corporation): 100 parts by mass
Resin: polyvinyl butyral (trade name: S-LEC BL-1, manufactured by Sekisui Chemical Co., Ltd.): 15 parts by mass
Particle A: carbon black (trade name: MONAHRCH 1000, manufactured by Cabot Corporation): 15 parts by mass
Particle B: polyamide particles (POLYAMIDE 12, manufactured by Arkema S.A.): 10 parts by mass
Additive: dimethylpolysiloxane (BYK-307, manufactured by Altana AG): 1 part by mass

A mixture having the above-described composition is diluted with methanol/1-propanol, the surface of the conductive elastic roll A is immersed in and coated with the dispersion liquid obtained by dispersion with a bead mill in an environment of room temperature (24° C.) and a relative humidity of 45%, and heated and dried at 130° C. for 30 minutes, thereby forming a surface layer having a thickness of 10 μm.

In the above-described manner, a charging member (charging roll) 1 having a surface with a water contact angle θ2 of 75° is obtained.

### Preparation of Charging Roller 2

A charging roll 2 having a surface with a water contact angle θ2 of 66° is obtained in the same manner as in the preparation of the charging roll 1 except that the amount of the polyvinyl butyral used for formation of the surface layer is changed to 10 parts by mass from 15 parts by mass.

### Preparation of Charging Roller 3

A charging roll 3 having a surface with a water contact angle θ2 of 66° is obtained in the same manner as in the preparation of the charging roll 1 except that the environment in a case of the immersion and coating during the formation of the surface layer is changed to a room temperature (28° C.) and a relative humidity of 40%.

### Preparation of Charging Roller 4

A charging roll 4 having a surface with a water contact angle θ2 of 76° is obtained in the same manner as in the preparation of the charging roll 1 except that the amount of the polyvinyl butyral used for formation of the surface layer is changed to 30 parts by mass from 15 parts by mass.

### Preparation of Charging Roller 5

A charging roll 5 having a surface with a water contact angle θ2 of 85° is obtained in the same manner as in the preparation of the charging roll 1 except that the N-methoxymethylated nylon used for formation of the surface layer is changed to a bisphenol Z polycarbonate resin (polycarbonate resin represented by Formula (PC-1), pm: 25, pn: 75, viscosity average molecular weight of 10,000) and the diluent methanol/1-propanol is changed to tetrahydrofuran (THF).

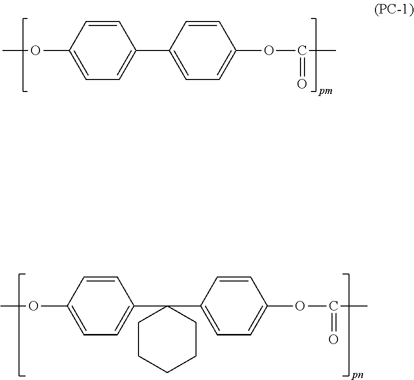

### Examples 1 to 6 and Comparative Examples 1 to 5

Each process cartridge including the photoreceptors and the charging roll in the combinations listed in Table 1 below is prepared and mounted on an image forming apparatus (Apeos C2360, manufactured by FUJIFILM Business Innovation Corporation).

The following evaluation is performed using this image forming apparatus.

### Image Quality Evaluation 1 (Density Unevenness in Entire Image)

6000 sheets of black halftone images with an image density of 30% are output in an environment of room temperature (10° C.) and a humidity of 15% RH. Reflection densities D of the printed portions of the output image at the initial stage of image formation (specifically, the 10th image) and the 6000th output image are measured using an X-Rite 404A densitometer, and a density difference ΔD is acquired at four sites on the paper edge and one site at the center. Based on the obtained density difference ΔD, the image quality is evaluated according to the following standards.
G0: The density difference ΔD is 0.01 or less.
G1: The density difference ΔD is greater than 0.01 and 0.25 or less.
G2: The density difference ΔD is greater than 0.25 and 0.5 or less.
G3: The density difference ΔD is greater than 0.5 and 0.75 or less.
G4: The density difference ΔD is greater than 0.75.

### Image Quality Evaluation 2 (Streak-like Density Unevenness Caused By Contamination In Circumferential Direction (Image Defects))

Images are output by the same method as in the image quality evaluation 1. The 6000th output image is visually confirmed, and streak-like density unevenness (image defect) is evaluated according to the following standards.
G1: No streak-like image defect has occurred.
G2: Streak-like image defects have occurred.

TABLE 1

| | Photoreceptor | | | | | | | | | |
|---|---|---|---|---|---|---|---|---|---|---|
| | | | | | | | Leveling | Curing | | |
| | | | | Charge transport material Y | | | agent | catalyst | | |
| | | | | | Amount | | Amount | Amount | | Water |
| | | Compound X | | | in coating | | in coating | in coating | Heating | contact |
| | | | Content | | solution | Content | solution | solution | and drying | angle |
| | | | [% by | | [parts | [% by | [parts | [parts | temperature | θ1 |
| | Type | Type | mass] | Type | by mass] | mass] | by mass] | by mass | [° C.] | [°] |
| Example 1 | 1 | Methylated | 2.0 | I-16 | 45 | 97.9 | 0.1 | 0.01 | 150 | 74 |
| | | [symbol] resin | | I-8 | 52 | | | | | |
| Example 2 | 2 | [symbol] | 2.0 | I-16 | 45 | 97.9 | 0.1 | 0.01 | 150 | 72 |
| | | resin | | I-8 | 52 | | | | | |
| Example 3 | 3 | [symbol] | 2.6 | I-16 | 45 | 97.3 | 0.1 | 0.01 | 150 | 65 |
| | | resin | | I-10 | 50 | | | | | |
| Example 4 | 3 | [symbol] | 2.6 | I-16 | 45 | 97.3 | 0.1 | 0.01 | 150 | 65 |
| | | resin | | I-10 | 50 | | | | | |
| Example 5 | 4 | [symbol] | 2.5 | I-16 | 45 | 97.4 | 0.1 | 0.01 | 145 | 65 |
| | | resin | | I-8 | 52 | | | | | |
| Example 6 | 2 | [symbol] | 2.0 | I-16 | 45 | 97.9 | 0.1 | 0.01 | 150 | 72 |
| | | resin | | I-8 | 52 | | | | | |
| Comparative | 5 | [symbol] | 2.5 | I-16 | 45 | 97.4 | 0.1 | 0.01 | 140 | 64 |
| Example 1 | | resin | | I-8 | 52 | | | | | |
| Comparative | 6 | [symbol] | 2.0 | I-16 | 45 | 97.9 | 0.1 | 0.01 | 160 | 80 |
| Example 2 | | resin | | I-8 | 52 | | | | | |
| Comparative | 6 | [symbol] | 2.0 | I-16 | 45 | 97.9 | 0.1 | 0.01 | 160 | 80 |
| Example 3 | | resin | | I-8 | 52 | | | | | |
| Comparative | 1 | Methylated | 2.0 | I-16 | 45 | 97.9 | 0.1 | 0.01 | 150 | 74 |
| Example 4 | | [symbol] resin | | I-8 | 52 | | | | | |
| Comparative | 7 | — | — | — | — | — | — | — | — | 95 |
| Example 5 | | | | | | | | | | |

| | Charging roll | | | | | | | |
|---|---|---|---|---|---|---|---|---|
| | | | | Proportion | | | | |
| | | Water | Presence | of area | | | Evaluation | |
| | | contact | or [symbol] | of [symbol] | Diameter | | Image | Image |
| | | angle | of sea- | portion in | of island | Difference | quality | quality |
| | | θ2 | island | area of | portion | (θ2 − θ1) | evalua- | evalua- |
| | Type | [°] | structure | sea portion | [μm] | [°] | tion 1 | tion 2 |
| Example 1 | 1 | 75 | Present | 0.28 | 0.3 | 1 | G2 | G1 |
| Example 2 | 1 | 75 | Present | 0.28 | 0.3 | 3 | G1 | G1 |
| Example 3 | 1 | 75 | Present | 0.28 | 0.3 | 10 | G0 | G1 |
| Example 4 | 2 | 66 | Present | 0.22 | 0.2 | 1 | G2 | G1 |
| Example 5 | 3 | 66 | Present | 0.21 | 0.2 | 1 | G2 | G1 |
| Example 6 | 4 | 76 | Present | 0.70 | 1.5 | 4 | G1 | G1 |
| Comparative | 1 | 75 | Present | 0.28 | 0.3 | 11 | G1 | G2 |
| Example 1 | | | | | | | | |
| Comparative | 1 | 75 | Present | 0.28 | 0.3 | −5 | G3 | G2 |
| Example 2 | | | | | | | | |
| Comparative | 5 | 85 | Present | 0.30 | 0.2 | 5 | G3 | G2 |
| Example 3 | | | | | | | | |
| Comparative | 2 | 66 | Present | 0.22 | 0.2 | −8 | G3 | G1 |
| Example 4 | | | | | | | | |
| Comparative | 1 | 75 | Present | 0.28 | 0.3 | −20 | G4 | G2 |
| Example 5 | | | | | | | | |

[symbol]

indicates data missing or illegible when filed

Hereinafter, aspects of the present invention will be additionally described.
(((1))) A process cartridge comprising:
an electrophotographic photoreceptor that includes a photosensitive layer and a protective layer on a conductive substrate in this order; and
a charging member that includes an elastic layer and a surface layer on a conductive base material in this order and comes into contact with the electrophotographic photoreceptor to charge a surface of the electrophotographic photoreceptor,
wherein the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and
a water contact angle θ2 of a surface of the charging member satisfies a relationship of θ1<θ2.
(((2))) The process cartridge according to (((1))),
wherein a total content of the compound X in the cured film of the electrophotographic photoreceptor is 0.5% by mass or greater and 10.0% by mass or less.
(((3))) The process cartridge according to (((2))),
wherein the total content of the compound X in the cured film of the electrophotographic photoreceptor is 2.5% by mass or greater and 8.0% by mass or less.
(((4))) The process cartridge according to any one of (((1))) to (((3))),
wherein a surface of the surface layer in the charging member has a sea-island structure.
(((5))) The process cartridge according to (((4))),
wherein a proportion of an area of an island portion in an area of a sea portion in the sea-island structure is 0.21 or greater and 0.72 or less.
(((6))) The process cartridge according to (((4))) or (((5))),
wherein the island portion has a diameter of 0.2 μm or greater and 1.5 μm or less.
(((7))) The process cartridge according to any one of (((1))) to (((6))),
wherein a difference [θ2-θ1] between the water contact angle θ2 and the water contact angle θ1 is 1° or greater.
(((8))) The process cartridge according to (((7))),
wherein the difference [θ2-θ1] between the water contact angle θ2 and the water contact angle θ1 is 3º or greater.
(((9))) The process cartridge according to any one of (((1))) to (((8))),
wherein the water contact angle θ1 is 65° or greater and 75° or less.
(((10))) An image forming apparatus comprising:
an electrophotographic photoreceptor that includes a photosensitive layer and a protective layer on a conductive substrate in this order;
a charging member that includes an elastic layer and a surface layer on a conductive base material in this order and comes into contact with the electrophotographic photoreceptor to charge a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image formed on the surface of the electrophotographic photoreceptor to a surface of a recording medium,
wherein the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and
a water contact angle θ2 of a surface of the charging member satisfies a relationship of θ1<θ2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A process cartridge comprising:
an electrophotographic photoreceptor that includes a photosensitive layer and a protective layer on a conductive substrate in this order; and
a charging member that includes an elastic layer and a surface layer on a conductive base material in this order and comes into contact with the electrophotographic photoreceptor to charge a surface of the electrophotographic photoreceptor,
wherein the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and
a water contact angle θ2 of a surface of the charging member satisfies a relationship of θ1<θ2.

2. The process cartridge according to claim 1,
wherein a total content of the compound X in the cured film of the electrophotographic photoreceptor is 0.5% by mass or greater and 10.0% by mass or less.

3. The process cartridge according to claim 2,
wherein the total content of the compound X in the cured film of the electrophotographic photoreceptor is 2.5% by mass or greater and 8.0% by mass or less.

4. The process cartridge according to claim 1,
wherein a surface of the surface layer in the charging member has a sea-island structure.

5. The process cartridge according to claim 4,
wherein a proportion of an area of an island portion in an area of a sea portion in the sea-island structure is 0.21 or greater and 0.72 or less.

6. The process cartridge according to claim 5,
wherein the island portion has a diameter of 0.2 μm or greater and 1.5 μm or less.

7. The process cartridge according to claim 1,
wherein a difference [θ2-θ1] between the water contact angle θ2 and the water contact angle θ1 is 1° or greater.

8. The process cartridge according to claim 7,
wherein the difference [θ2-θ1] between the water contact angle θ2 and the water contact angle θ1 is 3º or greater.

9. The process cartridge according to claim 1,
wherein the water contact angle θ1 is 65° or greater and 75° or less.

10. An image forming apparatus comprising:
an electrophotographic photoreceptor that includes a photosensitive layer and a protective layer on a conductive substrate in this order;
a charging member that includes an elastic layer and a surface layer on a conductive base material in this order and comes into contact with the electrophotographic photoreceptor to charge a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image formed on the surface of the electrophotographic photoreceptor to a surface of a recording medium,
wherein the protective layer in the electrophotographic photoreceptor is a cured film formed to contain a crosslinked material of a composition containing at least one compound X selected from the group consisting of a compound having a guanamine structure and a compound having a melamine structure and a charge transport material Y containing at least one group selected from the group consisting of —OH, —OCH₃, —NH₂, —SH, and —COOH, a water contact angle θ1 of the surface of the electrophotographic photoreceptor is 65° or greater and less than 80°, and
a water contact angle θ2 of a surface of the charging member satisfies a relationship of θ1<θ2.
